(19) United States
(12) Patent Application Publication
(10) Pub. No.: US 2025/0036035 A1
(43) Pub. Date: Jan. 30, 2025

(54) ELECTROPHOTOGRAPHIC PHOTOCONDUCTOR, ELECTROPHOTOGRAPHIC PHOTOCONDUCTOR CARTRIDGE, AND IMAGE FORMATION DEVICE

(71) Applicant: MITSUBISHI CHEMICAL CORPORATION, Tokyo (JP)

(72) Inventors: Tsukasa HASEGAWA, Tokyo (JP); Manuel Emilio OTERO RAMIREZ, Tokyo (JP); Akira ANDO, Tokyo (JP)

(73) Assignee: MITSUBISHI CHEMICAL CORPORATION, Tokyo (JP)

(21) Appl. No.: 18/902,008

(22) Filed: Sep. 30, 2024

Related U.S. Application Data
(63) Continuation of application No. PCT/JP2023/012827, filed on Mar. 29, 2023.

(30) Foreign Application Priority Data
Mar. 30, 2022 (JP) 2022-055576

(51) Int. Cl. G03G 5/06; G03G 21/18

(52) U.S. Cl. CPC G03G 5/0631; G03G 5/0614; G03G 21/1814

(57) ABSTRACT

The present invention provides a novel electrophotographic photoconductor having at least a photosensitive layer and a protective layer on a conductive support, the protective layer containing an electron donating compound and preferably further containing an electron transporting compound, the electrophotographic photoconductor having good electrical properties, especially residual potential properties, even when a compound having an electron transporting structure is contained in the protective layer.

### TECHNICAL FIELD

The present invention relates to an electrophotographic photoconductor used in copiers, printers, and the like, and an electrophotographic photoconductor cartridge and an image formation device using the same.

### BACKGROUND ART

In printers, copiers, and the like, a charged organic photoconductor (OPC) drum is irradiated with light to form an electrostatic latent image by removing the electricity from the irradiated portion, and a toner adheres to the electrostatic latent image to provide an image. In devices using such electrophotographic technology, the photoconductor is a key member.

The organic photoconductor of this type leaves much room for material selection and the properties of the photoconductor can be easily controlled, and “function-separated photoconductors”, in which the functions of charge generation and transfer are shared by different compounds, are thus becoming mainstream. For example, there are known a single-layered electrophotographic photoconductor (hereinafter referred to as “single-layered photoconductor”) having a charge generation material (CGM) and a charge transport material (CTM) in the same layer, and a multi-layered electrophotographic photoconductor (hereinafter referred to as “multi-layered photoconductor”) having a charge generation layer containing a charge generation material (CGM) and a charge transport layer containing a charge transport material (CTM) laminated on each other. The photoconductor can be charged by a negative charging method, in which the surface of the photoconductor is negatively charged, or by a positive charging method, in which the surface of the photoconductor is positively charged.

The combinations of layer configurations and charging methods of the photoconductor currently in practical use include a “negatively-charged multi-layered photoconductor” and a “positively-charged single-layered photoconductor”.

The “negatively-charged multi-layered photoconductor” generally has a configuration in which an undercoat layer (UCL) made of a resin or the like is provided on a conductive substrate such as an aluminum tube, a charge generation layer (CGL) made of a charge generation material (CGM) and a resin or the like is provided thereon, and a charge transport layer (CTL) made of a hole transport material (HTM) and a resin or the like is further provided thereon.

The “positively-charged single-layered photoconductor” generally has a configuration in which an undercoat layer (UCL) made of a resin or the like is provided on a conductive substrate such as an aluminum tube, and a single-layered photosensitive layer made of a charge generation material (CGM), a hole transport material (HTM), an electron transport material (ETM), and a resin or the like is provided thereon (see, for example, Patent Literature 1).

In both types of photoconductors, the surface of the photoconductor is charged by a corona discharging method or a contact method, and the photoconductor is then exposed to light to neutralize the charge on the surface, thereby forming an electrostatic latent image by the potential difference with the surrounding surface. Thereafter, a toner is brought into contact with the surface of the photoconductor to form a toner image corresponding to the electrostatic latent image, and the toner image is transferred to paper or the like and heat-melted and fixed to complete printing.

The electrophotographic photoconductor includes, as a basic configuration, a conductive support and a photosensitive layer formed on the conductive support as described above, and further includes a protective layer provided on the photosensitive layer for the purpose of improving abrasion resistance and the like.

As technologies for improving the mechanical strength or abrasion resistance of the surface of the photoconductor, there are disclosed photoconductors in which a layer containing a chain polymerizable functional group-containing compound as a binder resin is formed on an outermost layer of the photoconductor, and is polymerized by applying energy such as heat, light, or radiation to form a cured resin layer (see, for example, Patent Literatures 1 and 2).

### CITATION LIST

### Patent Literature

Patent Literature 1: U.S. Pat. No. 9,417,538
Patent Literature 2: International Publication No. 2010/035683 (U.S. Pat. No. 5,263,296)

### SUMMARY OF THE INVENTION

### Problem to be Solved by the Invention

As described above, protective layers are being implemented to improve the abrasion resistance of photoconductors. Among them, protective layers that use curable compounds are particularly excellent in mechanical strength.

Such protective layers are required to have electron transportability from the viewpoint of improving the electrical properties of photoconductors. As a means to achieve this, it is considered effective to incorporate compounds having electron transporting structures into protective layers that use curable compounds.

However, it has been found that some compounds having electron transporting structures have insufficient electrical properties, especially residual potential properties, when incorporated into protective layers.

Thus, an object of the present invention is to provide a novel electrophotographic photoconductor having a photosensitive layer and a protective layer in sequence on a conductive support and capable of achieving good electrical properties, especially residual potential properties.

### Means for Solving Problem

As a result of the investigations of the present inventors, it has been found that the above problem can be solved with an electrophotographic photoconductor having at least a photosensitive layer and a protective layer in sequence on a conductive support, wherein the protective layer contains an electron donating compound. It has also been found that even when the protective layer contains an electron donating compound, the potential retention rate, hardness, and elastic deformation rate remain the same and good.

Accordingly, the present invention proposes electrophotographic photoconductors in the following embodiments, and an electrophotographic photoconductor cartridge and an image formation device.

A first embodiment of the present invention proposes an electrophotographic photoconductor having at least a photosensitive layer and a protective layer in sequence on a conductive support,
wherein the protective layer contains an electron donating compound and a cured product obtained by curing a photocurable compound, and
the electron donating compound is a compound having a benzimidazole structure or a guanidine structure.

A second embodiment of the present invention proposes an electrophotographic photoconductor having at least a photosensitive layer and a protective layer in sequence on a conductive support,
wherein the protective layer contains an electron donating compound,
the electron donating compound is a compound having a benzimidazole structure or a guanidine structure, and
a content of the electron donating compound in the protective layer is 0.62 part by mass or more relative to a total mass of the protective layer being 100 parts by mass.

A third embodiment of the present invention proposes an electrophotographic photoconductor having at least a photosensitive layer and a protective layer in sequence on a conductive support,
wherein the protective layer contains an electron donating compound and an electron transporting compound, and
a content mass ratio of the electron donating compound to the electron transporting compound is 0.001 or more and 0.8 or less.

Specifically, the gist of the present invention is set forth in the following [1] to [15].

[1] An electrophotographic photoconductor having at least a photosensitive layer and a protective layer in sequence on a conductive support,
wherein the protective layer contains an electron donating compound and a cured product obtained by curing a photocurable compound, and
the electron donating compound is a compound having a benzimidazole structure or a guanidine structure.
   [2] An electrophotographic photoconductor having at least a photosensitive layer and a protective layer in sequence on a conductive support,
wherein the protective layer contains an electron donating compound,
the electron donating compound is a compound having a benzimidazole structure or a guanidine structure, and
a content of the electron donating compound in the protective layer is 0.62 part by mass or more relative to a total mass of the protective layer being 100 parts by mass.
   [3] An electrophotographic photoconductor having at least a photosensitive layer and a protective layer in sequence on a conductive support,
wherein the protective layer contains an electron donating compound and an electron transporting compound, and
a content mass ratio of the electron donating compound to the electron transporting compound is 0.001 or more and 0.8 or less.
   [4] The electrophotographic photoconductor according to the above [3], wherein the electron donating compound is a compound having a molecule with two or more nitrogen atoms.
   [5] The electrophotographic photoconductor according to the above [3] or [4], wherein the electron donating compound is a compound having a benzimidazole structure or a guanidine structure.
   [6] The electrophotographic photoconductor according to any one of the above [1] to [5], wherein the electron donating compound is a compound represented by the following formula (2) or (3).

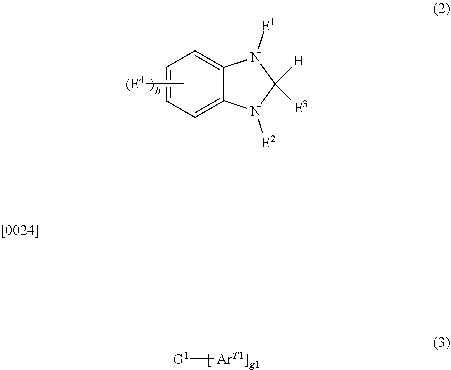

In the formula (2), E¹ to E⁴ each independently represent a hydrogen atom, a halogen atom, an optionally substituted alkyl group, an optionally substituted thioalkyl group, an optionally substituted thioaryl group, an optionally substituted arylsulfonyl group, an optionally substituted amino group, an optionally substituted alkylamino group, an optionally substituted arylamino group, an optionally substituted hydroxy group, an optionally substituted alkoxy group, an optionally substituted acylamino group, an optionally substituted acyloxy group, an optionally substituted aromatic hydrocarbon group, an optionally substituted carboxy group, an optionally substituted carboxamido group, an optionally substituted carboalkoxy group, an optionally substituted acyl group, an optionally substituted sulfonyl group, an optionally substituted cyano group, an optionally substituted nitro group, or a derivative of any of them. E¹ to E⁴ may be bonded to each other to form a ring. h represents an integer of 0 or more.

In the formula (3), Ar^{T1} is represented by the following formula (4), G¹ represents an optionally substituted hydrocarbon group, and g1 represents an integer of 1 or more.

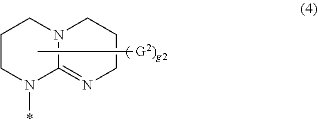

In the formula (4), the asterisk (*) represents a bond with G¹ in the formula (3), G² represents an optionally substituted alkyl group, an optionally substituted alkoxy group, or a halogen atom, and g2 represents an integer of 0 or more.

[7] The electrophotographic photoconductor according to the above [6], wherein the electron donating compound is at least one selected from the group consisting of compounds represented by the following formulae.

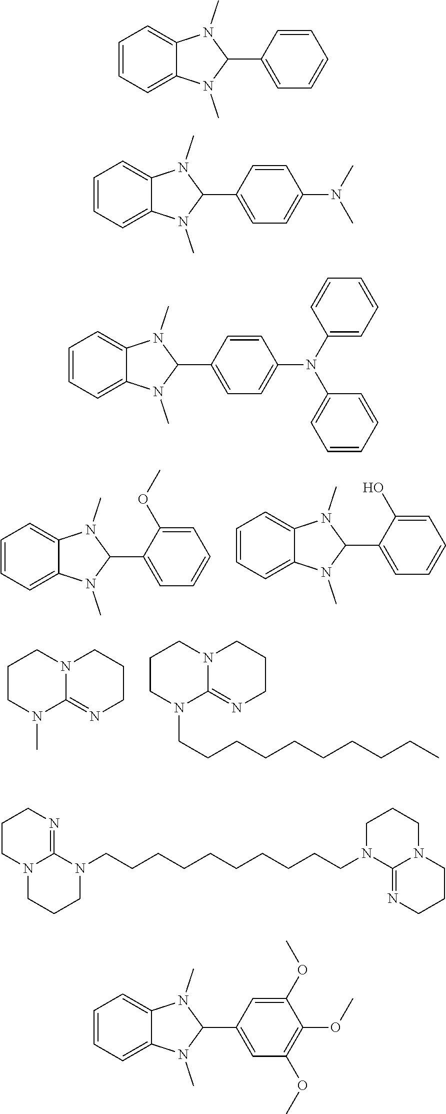

[8] The electrophotographic photoconductor according to any one of the above [1], [2], [6], and [7], wherein the protective layer further contains an electron transporting compound.
[9] The electrophotographic photoconductor according to the above [8], wherein a content mass ratio of the electron donating compound to the electron transporting compound is 0.001 or more and 1.0 or less.
[10] The electrophotographic photoconductor according to any one of the above [3] to [5], [8], and [9], wherein the electron transporting compound is an electron transporting compound represented by the following formula (1).

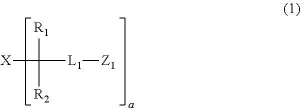

In the formula (1), X represents an electron transporting skeleton. R₁ and R₂ each independently represent a hydrogen atom, an optionally substituted alkyl group, an optionally substituted alkoxy group, an optionally substituted aryloxy group, an optionally substituted heteroaryloxy group, an optionally substituted alkoxycarbonyl group, an optionally substituted dialkylamino group, an optionally substituted diarylamino group, an optionally substituted arylalkylamino group, an optionally substituted acyl group, an optionally substituted haloalkyl group, an optionally substituted alkylthio group, an optionally substituted arylthio group, an optionally substituted silyl group, an optionally substituted siloxy group, an optionally substituted aromatic hydrocarbon group, or an optionally substituted aromatic heterocyclic group. L₁ represents a divalent group. Z₁ represents a hydrogen atom, an alkoxy group, an amide group (—NHCO—R′), an acrylamide group, a methacrylamide group, an acryloyl group, or a methacryloyl group, where the aforementioned R′ represents a hydrogen atom, an optionally substituted alkyl group, an optionally substituted aralkyl group, or an optionally substituted aromatic group.
a represents an integer of 1 or more. When a is an integer of 2 or more, each of R₁, R₂, L₁, and Z₁ may be the same or different in the repeating structure.
   [11] The electrophotographic photoconductor according to the above [10], wherein X in the formula (1) has a structure selected from the group consisting of formulae (A-1) to (A-13) described later when the bonding site is substituted to a hydrogen atom.

In the formulae (A-1) to (A-13) described later, P₁ to P₂₁ each independently represent a hydrogen atom, an optionally substituted alkyl group, an optionally substituted aralkyl group, an optionally substituted aromatic group, an optionally substituted alkoxy group, an optionally substituted aryloxy group, an optionally substituted acyl group, an optionally substituted ester group, an optionally substituted cyano group, an optionally substituted nitro group, an optionally substituted sulfone group, an optionally substituted hydroxy group, an optionally substituted aldehyde group, or a halogen atom. m1 to m10 each independently represent an integer of 0 or more. When m1 to m10 are each an integer of 2 or more, each of P₆ to P₁₅ may be the same or different in the repeating structure. Q₁ to Q₂₄ each independently represent either an oxygen atom, a sulfur atom, C(CN)₂, CR″CN, CA₂, C(COOR″)₂, CR′COOR″, NR″, or NCR″, where the aforementioned A represents a halogen atom, and the aforementioned R″ represents a hydrogen atom, an optionally substituted alkyl group, an optionally substituted alkoxy group, an optionally substituted aryloxy group, an optionally substituted heteroaryloxy group, an optionally substituted alkoxycarbonyl group, an optionally substituted dialkylamino group, an optionally substituted diarylamino group, an optionally substituted arylalkylamino group, an optionally substituted acyl group, an optionally substituted haloalkyl group, an optionally substituted alkylthio group, an optionally substituted arylthio group, an optionally substituted silyl group, an optionally substituted siloxy group, an optionally substituted aromatic hydrocarbon group, or an optionally substituted aromatic heterocyclic group. Ar₁ to Ar₁₉ each independently represent an optionally substituted aromatic group or an optionally substituted heteroaromatic group.

[12] The electrophotographic photoconductor according to the above [10] or [11], wherein X in the formula (1) has a structure selected from the group consisting of formulae (B-1) to (B-38) described later when the bonding site is substituted to a hydrogen atom.

In the formulae (B-1) to (B-38) described later, P₁ to P₂₁ each independently represent a hydrogen atom, an optionally substituted alkyl group, an optionally substituted aralkyl group, an optionally substituted aromatic group, an optionally substituted alkoxy group, an optionally substituted aryloxy group, an optionally substituted acyl group, an optionally substituted ester group, an optionally substituted cyano group, an optionally substituted nitro group, an optionally substituted sulfone group, an optionally substituted hydroxy group, an optionally substituted aldehyde group, or a halogen atom. m1 to m10 each independently represent an integer of 0 or more. When m1 to m10 are each an integer of 2 or more, each of P₆ to P₁₅ may be the same or different in the repeating structure.

[13] The electrophotographic photoconductor according to any one of the above [10] to [12], wherein L₁ in the formula (1) represents an alkylene group, a divalent group having a ketone group, a divalent group having an ether bond, a divalent group having an ester bond, or a group in which these are linked.
[14] An electrophotographic photoconductor cartridge including the electrophotographic photoconductor according to any one of the above [1] to [13].
[15] An image formation device including the electrophotographic photoconductor according to any one of the above [1] to [13].

### Effect of the Invention

The electrophotographic photoconductor proposed by the present invention has a protective layer containing an electron donating compound, i.e., an electron dopant, which can improve the electron conductivity (electron transportability) in the protective layer, thereby improving the electrical properties of the electrophotographic photoconductor, especially the residual potential properties. In addition, even when the protective layer contains an electron donating compound, the potential retention rate, hardness, and elastic deformation rate remain the same and good.

### BRIEF DESCRIPTION OF DRAWINGS

FIG. 1 is a schematic diagram of an example configuration of an image formation device that can be configured using an electrophotographic photoconductor according to one example of the present invention.

FIG. 2 is a graph of a general relationship between the indentation depth of an indenter and the load curve when measuring the Martens hardness and the elastic deformation rate of the photoconductor.

### MODE(S) FOR CARRYING OUT THE INVENTION

Modes for carrying out the present invention (hereinafter referred to as embodiments of the present invention) are described in detail below. The present invention is not to be limited to the following embodiments, and may be implemented with various modifications within the scope of the gist thereof.

### <<Present Electrophotographic Photoconductor>>

The electrophotographic photoconductor according to an example of the embodiments of the present invention (also referred to as “the present electrophotographic photoconductor”) is an electrophotographic photoconductor including at least a photosensitive layer and a protective layer in sequence on a conductive support.

The present electrophotographic photoconductor may optionally include other layers in addition to the photosensitive layer and the protective layer.

The charging method of the present electrophotographic photoconductor may be either a negative charging method in which the surface of the photoconductor is negatively charged, or a positive charging method in which the surface of the photoconductor is positively charged. Among them, the positive charging method is preferred because it is considered that the effects of the present invention can be obtained more effectively with the positive charging method from the viewpoint of seeking the electron transportability in the protective layer.

In the present electrophotographic photoconductor, the side opposite to the conductive support is an upper side or a front surface side, and the conductive support side is a lower side or a back surface side.

### <Present Protective Layer>

It is preferred that the present protective layer contains an electron donating compound. It is particularly preferred that the present protective layer further contains an electron transporting compound. It is further preferred that the present protective layer contains a cured product obtained by curing a curable compound.

That is, it is further preferred that the present protective layer contains, in addition to an electron donating compound, one or both of an electron transporting compound and a cured product obtained by curing a curable compound.

In the present invention, the “electron donating compound” means a compound that can donate electrons to the protective layer. In other words, the “electron donating compound” means a compound that can reduce the energy barrier during electron transfer in a target compound (electron transporting compound) in the protective layer by any mechanism, and can inject electrons into the target compound. The mechanism may be, for example, a mechanism in which electrons are transferred directly from the electron donating compound to the target compound, a mechanism in which electrons are transferred by forming a hydrogen bond between the electron donating compound and the target compound, or a mechanism in which an energy barrier during electron transfer is reduced by forming a hydrogen bond between the electron donating compound and the target compound, and the electrons transferred from the photosensitive layer are injected into the target compound present in the protective layer.

Examples of currently known electron donating compounds include compounds having structures such as triphenylmethane, acridine, amine, amidine, aniline, pyridine, xanthene, benzimidazole, guanidine, and phosphazene. Compounds known to have such effects in the future are also included.

In the present invention, the “electron transporting compound” means a compound having electron transportability, in other words, a compound having an electron transporting skeleton.

The present protective layer can be formed, for example, from a composition containing an electron donating compound and optionally an electron transporting compound, a curable compound, a polymerization initiator, inorganic particles, and other materials. However, the present protective layer is not limited to those formed from such a composition.

From the viewpoint of further obtaining the effect of the present invention, the present protective layer is preferably an outermost layer, i.e., an outermost layer located on the side opposite to the conductive support. However, the effect of the present invention can be obtained even when the protective layer is not necessarily the outermost layer. For example, if there is some kind of segregation layer is present on the outermost layer of the photoconductor, the effect can also be obtained even when the protective layer is not the outermost layer.

### (Electron Donating Compound)

As described above, examples of the electron donating compound include compounds having structures such as triphenylmethane, acridine, amine, amidine, aniline, pyridine, xanthene, benzimidazole, guanidine, and phosphazene. Among them, compounds having a benzimidazole structure or a guanidine structure are preferred from the viewpoint of stability. The guanidine structure can be either a chain guanidine structure or a cyclic guanidine structure. From the viewpoint of stability, a cyclic guanidine structure is preferred.

It is preferred that the electron donating compound is a compound having one or more heteroatoms in the molecule, and it is more preferred that the electron donating compound is a compound having one or more nitrogen atoms (N atoms) in the molecule. From the viewpoint of stability, the number of heteroatoms in one molecule of the electron donating compound is preferably one or more, more preferably two or more, and even more preferably three or more. From the viewpoint of electron donating ability, the number of nitrogen atoms (N atoms) in one molecule of the electron donating compound is preferably one or more, more preferably two or more, and even more preferably three or more.

It is also preferred that the electron donating compound is a compound having one or more cyclic structures from the viewpoint of stability.

The electron donating compound is preferably an electron donating compound represented by the following formula (2) or (3).

These electron donating compounds can be activated when heated to, for example, room temperature or higher to donate electrons to the present protective layer. Specifically, the electron donating compound represented by the following formula (2) can be activated when heated to approximately 80° C. or higher to donate electrons to the present protective layer. The electron donating compound represented by the following formula (3) can be activated when heated to room temperature or higher to donate electrons to the present protective layer. Therefore, these compounds can be activated by the temperature rise associated with ultraviolet irradiation during, for example, the formation of the present protective layer to donate electrons to the present protective layer.

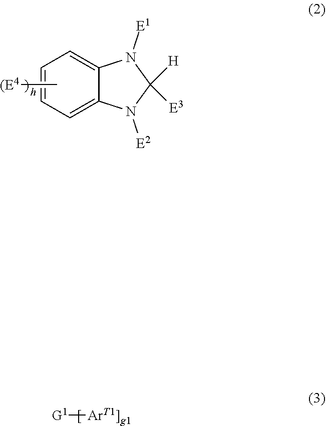

In the formula (2), it is preferred that E¹ to E⁴ are each independently a hydrogen atom, a halogen atom, an optionally substituted alkyl group, an optionally substituted thioalkyl group, an optionally substituted thioaryl group, an optionally substituted arylsulfonyl group, an optionally substituted amino group, an optionally substituted alkylamino group, an optionally substituted arylamino group, an optionally substituted hydroxy group, an optionally substituted alkoxy group, an optionally substituted acylamino group, an optionally substituted acyloxy group, an optionally substituted aromatic hydrocarbon group, an optionally substituted carboxy group, an optionally substituted carboxamido group, an optionally substituted carboalkoxy group, an optionally substituted acyl group, an optionally substituted sulfonyl group, an optionally substituted cyano group, an optionally substituted nitro group, or a derivative of any of these groups.

In addition, E¹ to E⁴ may be bonded to each other to form a ring.

In the present invention, the term “optionally substituted” means that the group may have a substituent and includes both the case of having a substituent and the case of not having a substituent.

In the formula (2), h is an integer of 0 or more, and from the viewpoint of stability, it is preferably 2 or less, more preferably 1 or less, and even more preferably 0.

In the formula (3), g1 is an integer of 1 or more, and from the viewpoint of electrical properties, it is preferably 4 or less, more preferably 3 or less, and even more preferably 2 or less.

In the formula (3), Ar^{T1} is preferably represented by the following formula (4).

G¹ is preferably an optionally substituted hydrocarbon group. The number of carbon atoms in the hydrocarbon group is preferably 1 or more, more preferably 3 or more; and is preferably 12 or less, more preferably 10 or less. When g1 is 1, the hydrocarbon group is preferably an alkyl group, and examples thereof include a methyl group, an ethyl group, a propyl group, an isopropyl group, a butyl group, a hexyl group, an octyl group, and a decyl group. When g1 is 2, the hydrocarbon group is preferably an alkylene group, and examples thereof include a methylene group and an ethylene group.

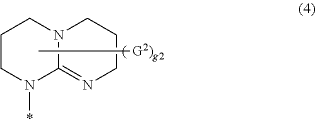

In the formula (4), the asterisk (*) represents a bond with G¹ in the formula (3).

G² is preferably an optionally substituted alkyl group, an optionally substituted alkoxy group, or a halogen atom.

In the formula (4), g2 is an integer of 0 or more, and from the viewpoint of stability, it is preferably 2 or less, more preferably 1 or less, and even more preferably 0.

The content of the electron donating compound in the present protective layer is preferably 0.10 part by mass or more, more preferably 0.62 part by mass or more, even more preferably 0.70 part by mass or more, still more preferably 1.0 part by mass or more, and still more preferably 2.0 parts by mass or more, relative to a total mass of the present protective layer being 100 parts by mass, from the viewpoint of electrical properties. In addition, it is preferably 50 parts by mass or less, more preferably 40 parts by mass or less, even more preferably 30 parts by mass or less, and among them, it is preferably 10 parts by mass or less, more preferably 5.0 parts by mass or less, even more preferably 3.0 parts by mass or less, and particularly preferably 2.5 parts by mass or less, relative to a total mass of the present protective layer being 100 parts by mass, from the viewpoint of electrical properties. The total mass of the protective layer means the total mass of the protective layer after curing, which is equal to the total mass of the solid content in the protective layer-forming coating liquid.

The following describes specific examples of the electron donating compound. However, it is not limited to these.

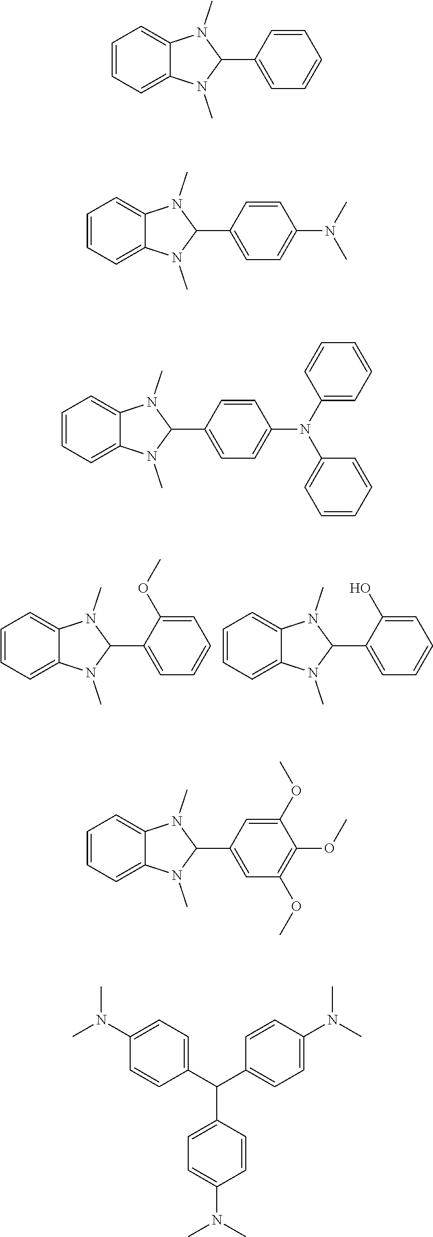

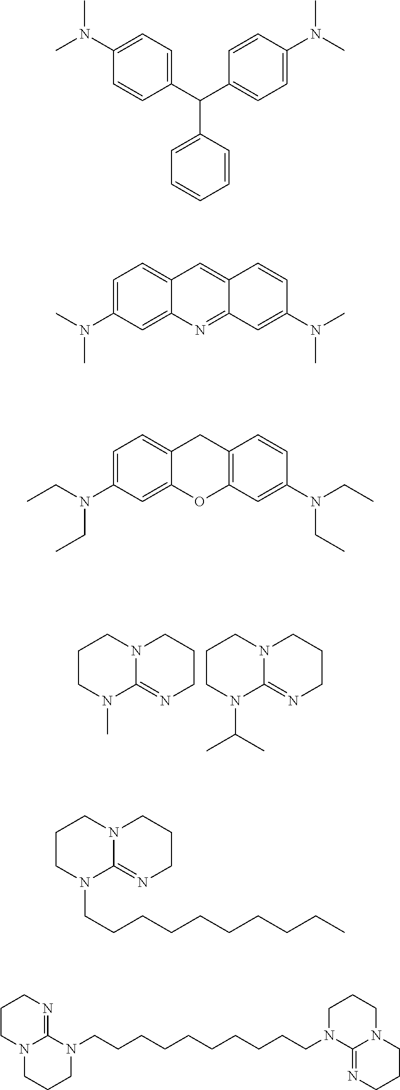

### (Electron Transporting Compound)

The electron transporting compound used in the present protective layer is preferably a compound represented by the following formula (1).

When the electron transporting compound is present in the present protective layer together with the electron donating compound, the electrons donated by the electron donating compound make the electron transporting compound more likely to receive electrons, which activates the performance, i.e., the electron transporting performance, and further increases the electron transporting performance of the present protective layer, thereby further improving the electrical properties of the present electrophotographic photoconductor, especially the residual potential properties.

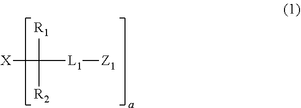

### [Electron Transporting Skeleton: X]

In the formula (1), X may be any structure having electron transportability, i.e., an electron transporting skeleton, and any known electron transporting skeleton can be appropriately adopted.

Examples of the electron transporting skeleton include an anthraquinone skeleton, a dinaphthoquinone skeleton, a benzenediimide skeleton, a naphthalene diimide skeleton, a perylene diimide skeleton, an isoindigo skeleton, a diketopyrrolopyrrole skeleton, a thiadiazole skeleton, and a pyrazine skeleton. Among them, from the viewpoint of electron transportability and solubility, a dinaphthoquinone skeleton, a benzenediimide skeleton, a naphthalene diimide skeleton, and a perylene diimide skeleton are preferred; a benzenediimide skeleton, a naphthalene diimide skeleton, and a perylene diimide skeleton are more preferred; and a benzenediimide skeleton and a naphthalene diimide skeleton are even more preferred.

X in the formula (1) preferably has a structure selected from the group consisting of the following formulae (A-1) to (A-13) when the bonding site is substituted to a hydrogen atom.

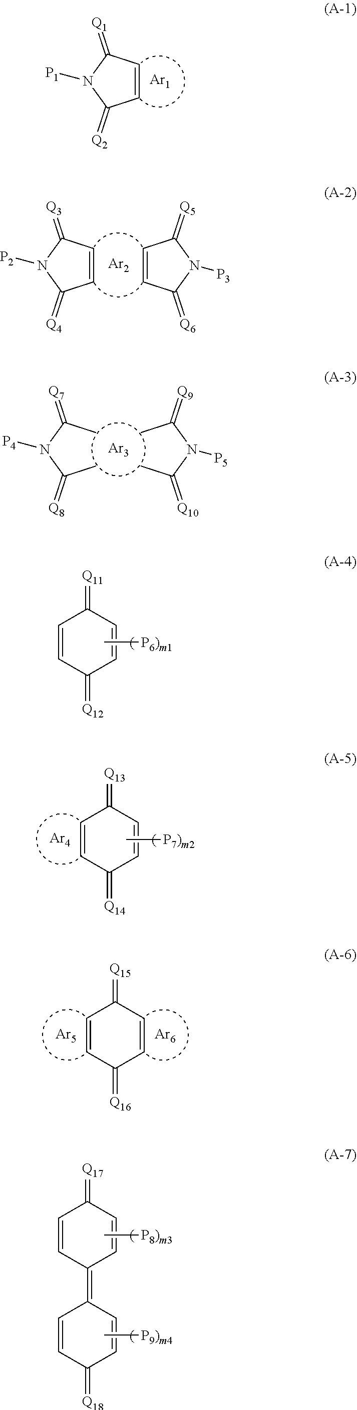

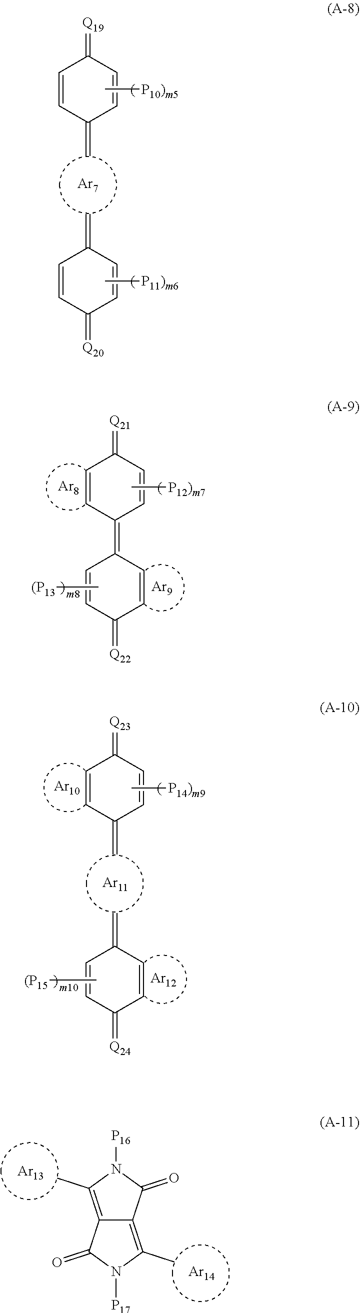

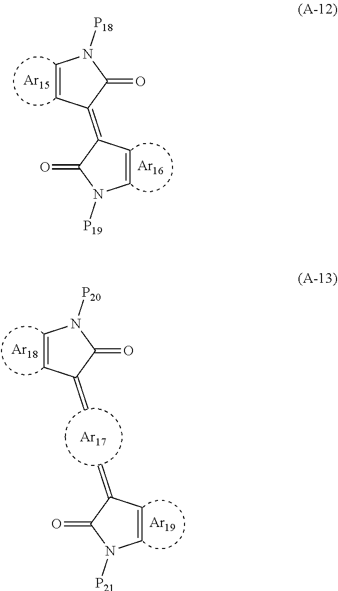

In the formulae (A-1) to (A-13), it is preferred that P₁ to P₂₁ are each independently a hydrogen atom, an optionally substituted alkyl group, an optionally substituted aralkyl group, an optionally substituted aromatic group, an optionally substituted alkoxy group, an optionally substituted aryloxy group, an optionally substituted acyl group, an optionally substituted ester group, an optionally substituted cyano group, an optionally substituted nitro group, an optionally substituted sulfone group, an optionally substituted hydroxy group, an optionally substituted aldehyde group, or a halogen atom.

Among them, from the viewpoint of solubility and curability, a hydrogen atom or an optionally substituted alkyl group is more preferred, and a hydrogen atom is even more preferred.

In the formulae (A-1) to (A-13), m1 to m10 may each independently be an integer of 0 or more. Among them, from the viewpoint of solubility and curability, it is preferred that m1 to m10 are each independently an integer of 1 or more.

When m1 to m10 are each an integer of 2 or more, each of P₆ to P₁₅ may be the same or different in the repeating structure.

In the formulae (A-1) to (A-13), it is preferred that Q₁ to Q₂₄ are each independently either an oxygen atom, a sulfur atom, C(CN)₂, CR″CN, CA₂, C(COOR″)₂, CR′COOR″, NR″, or NCR″. Among them, from the viewpoint of electron transportability, an oxygen atom, C(CN)₂, or CR″CN is more preferred, and an oxygen atom or C(CN)₂ is even more preferred.

The aforementioned A represents a halogen atom; and the aforementioned R″ is preferably a hydrogen atom, an optionally substituted alkyl group, an optionally substituted alkoxy group, an optionally substituted aryloxy group, an optionally substituted heteroaryloxy group, an optionally substituted alkoxycarbonyl group, an optionally substituted dialkylamino group, an optionally substituted diarylamino group, an optionally substituted arylalkylamino group, an optionally substituted acyl group, an optionally substituted haloalkyl group, an optionally substituted alkylthio group, an optionally substituted arylthio group, an optionally substituted silyl group, an optionally substituted siloxy group, an optionally substituted aromatic hydrocarbon group, or an optionally substituted aromatic heterocyclic group. Among them, from the viewpoint of solubility, the aforementioned R″ is more preferably an alkyl group, an alkoxy group, or an aromatic hydrocarbon group, and even more preferably an alkyl group.

In the formulae (A-1) to (A-13), it is preferred that Ar₁ to Ar₁₉ are each independently an optionally substituted aromatic group or an optionally substituted heteroaromatic group. Among them, from the viewpoint of solubility, an optionally substituted aromatic group is more preferred.

Among the formulae (A-1) to (A-13), from the viewpoint of electron transportability, (A-1), (A-2), (A-3), (A-6), and (A-9) are preferred; (A-2), (A-3), and (A-9) are more preferred; and (A-2) and (A-3) are even more preferred.

X in the formula (1) preferably has a structure selected from the group consisting of the following formulae (B-1) to (B-38) when the bonding site is substituted to a hydrogen atom.

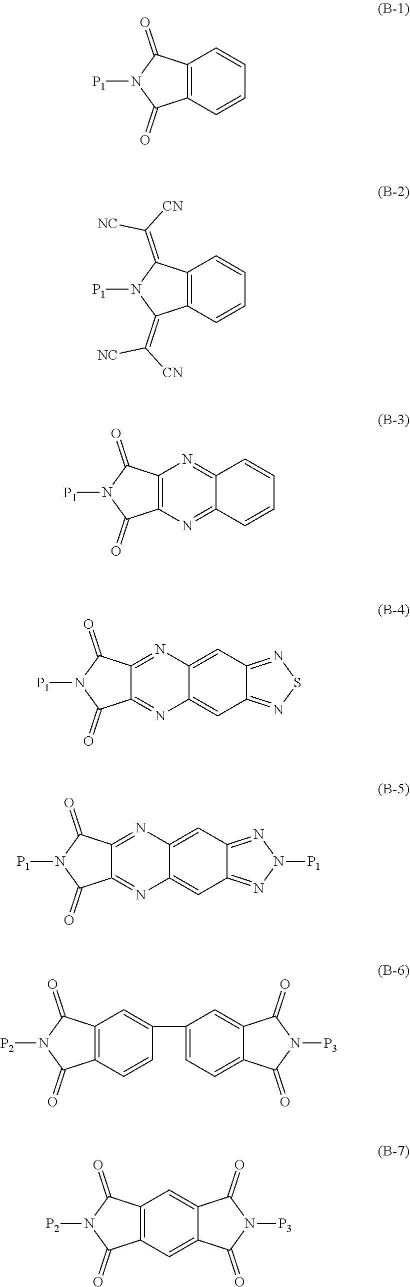

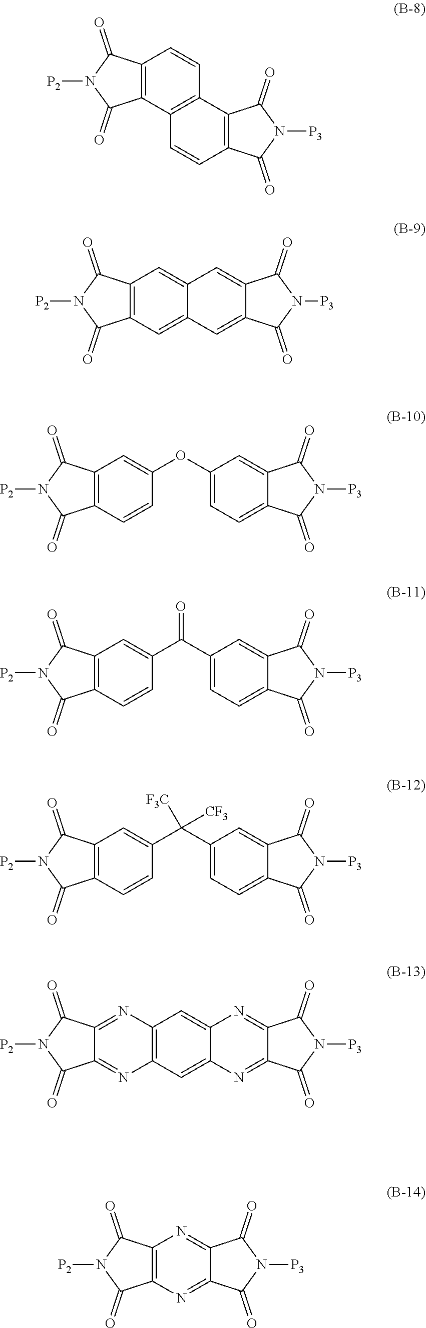

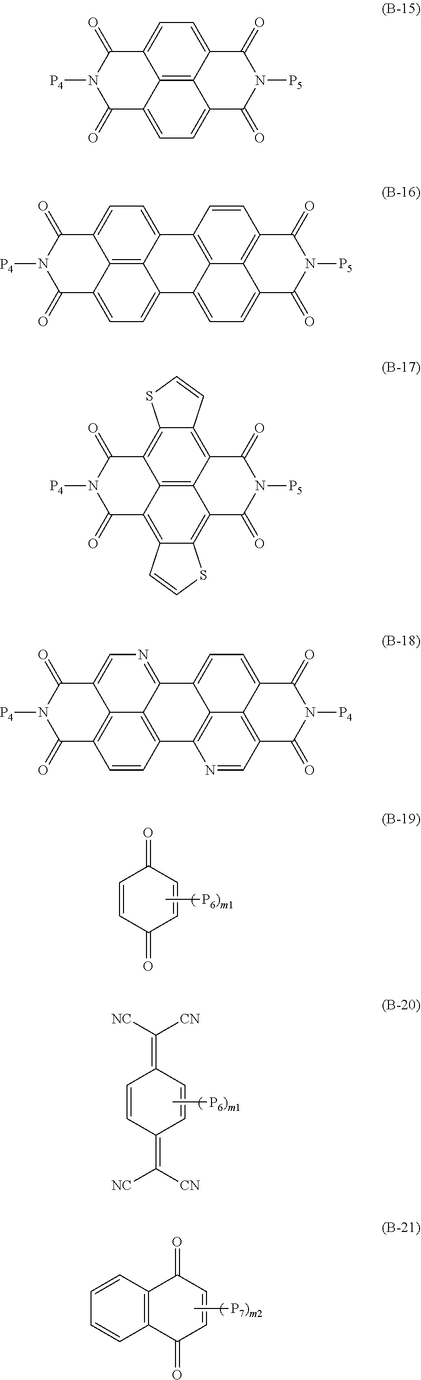

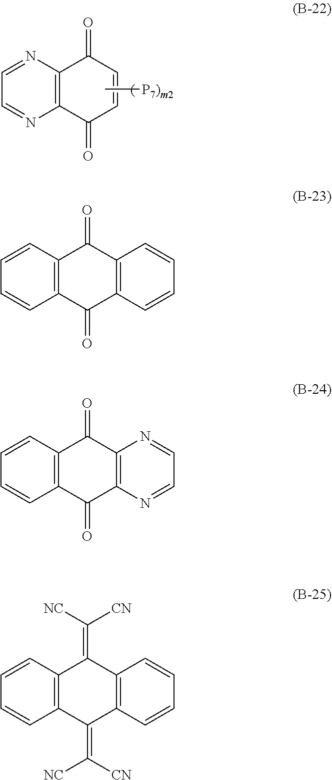

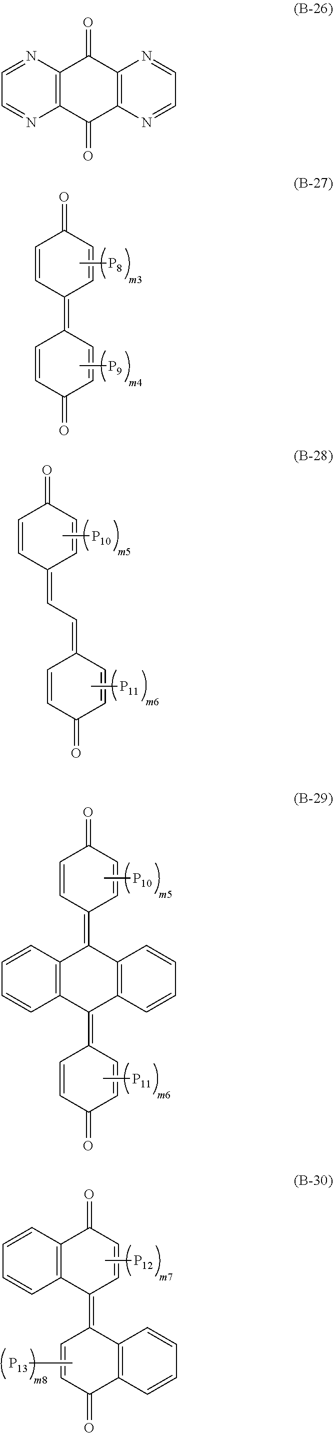

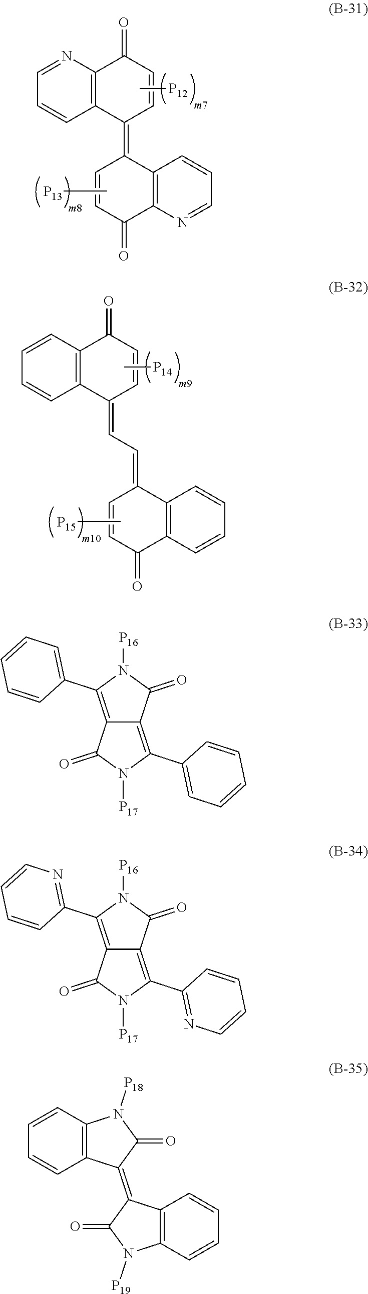

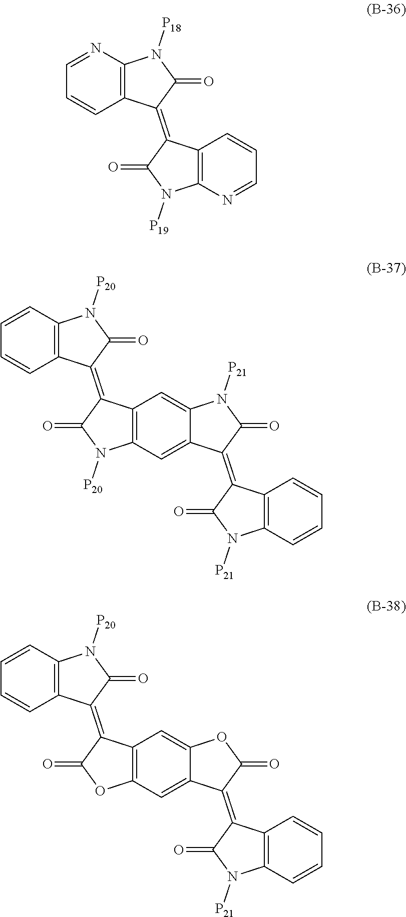

In the formulae (B-1) to (B-38), it is preferred that P₁ to P₂₁ are each independently a hydrogen atom, an optionally substituted alkyl group, an optionally substituted aralkyl group, an optionally substituted aromatic group, an optionally substituted alkoxy group, an optionally substituted aryloxy group, an optionally substituted acyl group, an optionally substituted ester group, an optionally substituted cyano group, an optionally substituted nitro group, an optionally substituted sulfone group, an optionally substituted hydroxy group, an optionally substituted aldehyde group, or a halogen atom.

Among them, from the viewpoint of solubility and curability, a hydrogen atom or an optionally substituted alkyl group is more preferred, and a hydrogen atom is even more preferred.

In the formulae (B-1) to (B-38), m1 to m10 may each independently be an integer of 0 or more.

Among them, from the viewpoint of solubility and curability, it is preferred that m1 to m10 are each independently an integer of 1 or more.

When m1 to m10 are each an integer of 2 or more, each of P₆ to P₁₅ may be the same or different in the repeating structure.

Among the formulae (B-1) to (B-38), from the viewpoint of solubility and electron transportability, (B-1), (B-2), (B-7), (B-12), (B-14), (B-15), (B-16), (B-24), and (B-30) are preferred; (B-7), (B-12), (B-14), (B-15), (B-16), and (B-30) are more preferred; and (B-7), (B-14), (B-15), and (B-16) are even more preferred.

### [Z₁]

In the formula (1), Z₁ represents a hydrogen atom, an alkoxy group, an amide group (—NHCO—R′), an acrylamide group, a methacrylamide group, an acryloyl group, or a methacryloyl group.

R′ in the amide group (—NHCO—R′) represents a hydrogen atom, an optionally substituted alkyl group, an optionally substituted aralkyl group, or an optionally substituted aromatic group. Among them, an optionally substituted alkyl group is preferred from the viewpoint of solubility.

In the formula (1), Z₁ is preferably an alkoxy group, an amide group (—NHCO—R′), an acrylamide group, a methacrylamide group, an acryloyl group, or a methacryloyl group, and from the viewpoint of increasing the mechanical strength of the protective layer, it is more preferably an acrylamide group, a methacrylamide group, an acryloyl group, or a methacryloyl group. In other words, it is more preferred that at least one or more Z₁ in the formula (1) is an acrylamide group, a methacrylamide group, an acryloyl group, or a methacryloyl group. In this case, the group can also function as a chain polymerizable functional group and crosslink with a curable compound in the protective layer, resulting in better mechanical strength of the protective layer, such as hardness and elastic deformation rate.

[R₁, R₂]

In the formula (1), it is preferred that R₁ and R₂ are each independently a hydrogen atom, an optionally substituted alkyl group, an optionally substituted alkoxy group, an optionally substituted aryloxy group, an optionally substituted heteroaryloxy group, an optionally substituted alkoxycarbonyl group, an optionally substituted dialkylamino group, an optionally substituted diarylamino group, an optionally substituted arylalkylamino group, an optionally substituted acyl group, an optionally substituted haloalkyl group, an optionally substituted alkylthio group, an optionally substituted arylthio group, an optionally substituted silyl group, an optionally substituted siloxy group, an optionally substituted aromatic hydrocarbon group, or an optionally substituted aromatic heterocyclic group.

Among them, from the viewpoint of solubility, a hydrogen atom or an optionally substituted alkyl group is more preferred.

In the formula (1), it is particularly preferred that at least one of R₁ and R₂ is an optionally substituted alkyl group having two or more carbon atoms because this provides an even more excellent effect in terms of dark decay.

### [L₁]

In the formula (1), L₁ may be a divalent group. Examples thereof include an alkylene group, a divalent group having a ketone group, a divalent group having an ether bond, a divalent group having an ester bond, and a group in which these are linked. However, it is not limited to these. Among them, from the viewpoint of solubility, the structures represented by the following formulae (L-1) to (L-5) are preferred, and the formulae (L-3), (L-4), and (L-5) are more preferred.

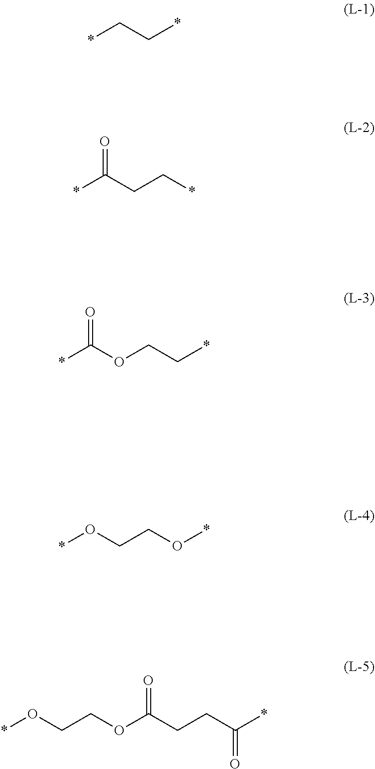

In the formulae (L-1) to (L-5), the asterisk (*) represents a site bonded to the carbon atom to which R₁ and R₂ are bonded in the formula (1) or to Z₁.

In the formula (1), L₁ is a bonding site that bonds the carbon atom to which R₁ and R₂ are bonded to Z₁, and can also be regarded as a bonding site that bonds the electron transporting skeleton to Z₁, since the carbon atom to which R₁ and R₂ are bonded is further bonded to the electron transporting skeleton. The aforementioned Z₁ is less likely to interact with the electron transporting skeleton when it is located farther away from the electron transporting skeleton, and especially when Z₁ contains an amide bond, the effect of the amide bond, i.e., the effect of increasing affinity with a solvent, is considered to be stronger. From such a viewpoint, it is considered that L₁ preferably has four or more atoms in the main chain.

[a]

In the formula (1), the portion other than X, which is the electron transporting skeleton, may be a repeating structure, and a in the formula (1) indicates the number of such repeating structures.

Specifically, in the formula (1), a may be an integer of 1 or more, and from the viewpoint of solubility and curability, it is preferably 2 or more.

When a is an integer of 2 or more, each of R₁, R₂, L₁, and Z₁ may be the same or different in the repeating structure in the formula (1).

The following describes specific examples of the electron transporting compound. However, it is not limited to these.

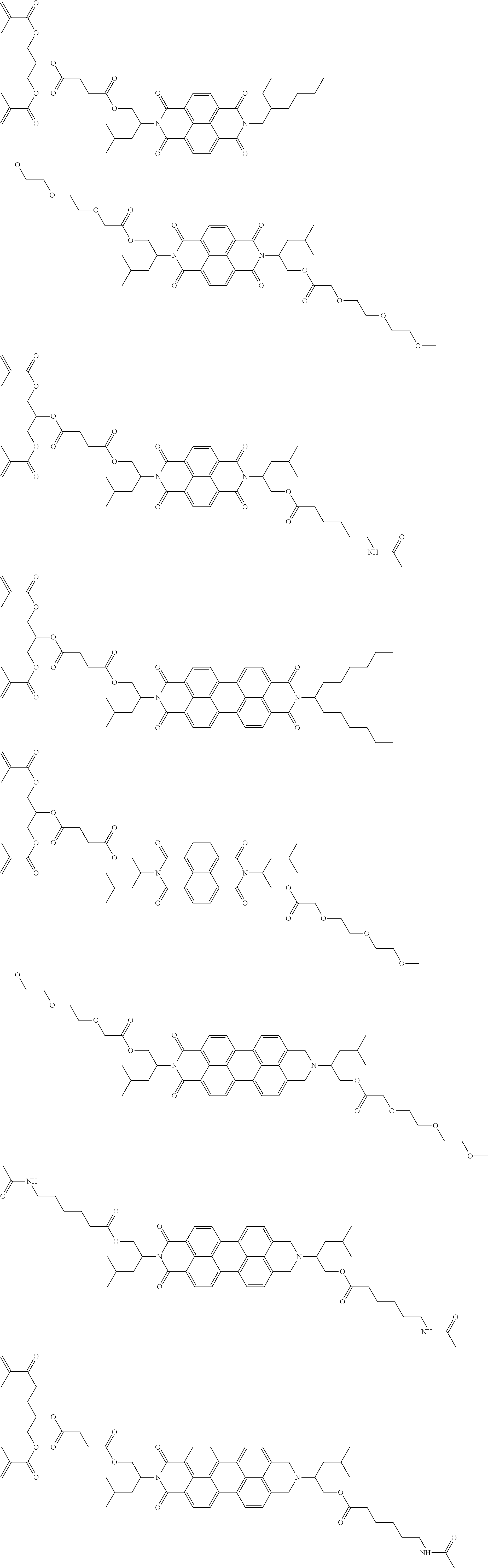

The content of the electron transporting compound in the present protective layer is preferably 40 parts by mass or more, more preferably 60 parts by mass or more, and even more preferably 80 parts by mass or more, relative to a total mass of the present protective layer being 100 parts by mass, from the viewpoint of electron transportability. The total mass of the protective layer means the total mass of the protective layer after curing, which is equal to the total mass of the solid content in the protective layer-forming coating liquid.

### (Content Ratio of Electron Donating Compound and Electron Transporting Compound)

The content mass ratio of the electron donating compound to the electron transporting compound (electron donating compound/electron transporting compound) is preferably 0.001 or more, more preferably 0.005 or more, even more preferably 0.01 or more, and still more preferably 0.02 or more, from the viewpoint of electrical properties. In addition, it is preferably 1.0 or less, more preferably 0.8 or less, even more preferably 0.7 or less, still more preferably 0.6 or less, still more preferably 0.4 or less, still more preferably 0.1 or less, and particularly preferably 0.04 or less, from the viewpoint of electrical properties.

### (Curable Compound)

The curable compound may be any compound having a chain polymerizable functional group. Among them, monomers, oligomers, or polymers having a radical polymerizable functional group are preferred. Among them, curable compounds having crosslinking properties, especially photocurable compounds, are preferred. Examples thereof include curable compounds having two or more radical polymerizable functional groups. Compounds having one radical polymerizable functional group may be used in combination.

The radical polymerizable functional groups may include either acryloyl groups (including acryloyloxy groups) or methacryloyl groups (including methacryloyloxy groups), or both of these groups.

The following are examples of preferred compounds as photocurable compounds having radical polymerizable functional groups.

Examples of the monomer having an acryloyl group or a methacryloyl group include trimethylolpropane triacrylate (TMPTA), trimethylolpropane trimethacrylate, pentaerythritol triacrylate, pentaerythritol tetraacrylate, glycerol triacrylate, tris(acryloxyethyl) isocyanurate, dipentaerythritol hexaacrylate, dimethylolpropane tetraacrylate, pentaerythritol ethoxytetraacrylate, EO-modified phosphate triacrylate, 2,2,5,5-tetrahydroxymethylcyclopentanone tetraacrylate, 2-hydroxy-3-acryloyloxypropyl methacrylate, polyethylene glycol diacrylate, polypropylene glycol diacrylate, polytetramethylene glycol diacrylate, EO-modified bisphenol A diacrylate, PO-modified bisphenol A diacrylate, 9,9-bis[4-(2-acryloyloxyethoxy)phenyl]fluorene, tricyclodecane dimethanol diacrylate, decanediol diacrylate, hexanediol diacrylate, ethylene glycol dimethacrylate, polyethylene glycol dimethacrylate, EO-modified bisphenol A dimethacrylate, PO-modified bisphenol A dimethacrylate, tricyclodecane dimethanol dimethacrylate, decanediol dimethacrylate, and hexanediol dimethacrylate.

Examples of the oligomer and the polymer having an acryloyl group or a methacryloyl group include urethane acrylate, ester acrylate, acrylic acrylate, and epoxy acrylate. Among them, urethane acrylate and ester acrylate are preferred, and ester acrylate is more preferred.

These curable compounds may be used alone or in a combination of two or more types.

The content mass ratio of the curable compound to the electron donating compound (curable compound/electron donating compound) in the present protective layer is preferably 40 or less, more preferably 30 or less, and even more preferably 20 or less, from the viewpoint of electron transportability.

The content mass ratio of the curable compound to the electron transporting compound (curable compound/electron transporting compound) in the present protective layer is preferably 1.0 or less, more preferably 0.5 or less, and even more preferably 0.1 or less, from the viewpoint of electron transportability.

### (Polymerization Initiator)

Examples of the polymerization initiator include a thermal polymerization initiator and a photopolymerization initiator.

Examples of the thermal polymerization initiator include peroxide-based compounds such as 2,5-dimethylhexane-2,5-dihydroperoxide, and azo-based compounds such as 2,2′-azobis(isobutyronitrile).

The photopolymerization initiator can be classified into a direct cleavage type and a hydrogen abstraction type based on the difference in radical generation mechanism.

The direct cleavage type photopolymerization initiator generates radicals by cleaving some of the covalent bonds in the molecule upon absorption of light energy. The hydrogen abstraction type photopolymerization initiator generates radicals by abstracting hydrogen from the hydrogen donor by excited molecules upon absorption of light energy.

Examples of the direct cleavage type photopolymerization initiator include: acetophenone-based or ketal-based compounds such as acetophenone, 2-benzoyl-2-propanol, 1-benzoylcyclohexanol, 2,2-diethoxyacetophenone, benzyl dimethyl ketal, and 2-methyl-4′-(methylthio)-2-morpholinopropiophenone; benzoin ether-based compounds such as benzoin, benzoin methyl ether, benzoin ethyl ether, benzoin isobutyl ether, benzoin isopropyl ether, and O-tosylbenzoin; and acylphosphine oxide-based compounds such as diphenyl(2,4,6-trimethylbenzoyl) phosphine oxide, phenylbis(2,4,6-trimethylbenzoyl)phosphine oxide, and lithium phenyl(2,4,6-trimethylbenzoyl)phosphonate.

Examples of the hydrogen abstraction type photopolymerization initiator include: benzophenone-based compounds such as benzophenone, 4-benzoylbenzoic acid, 2-benzoylbenzoic acid, methyl 2-benzoylbenzoate, methyl benzoylformate, benzyl, p-anisyl, 2-benzoylnaphthalene, 4,4′-bis(dimethylamino)benzophenone, 4,4′-dichlorobenzophenone, and 1,4-dibenzoylbenzene; and anthraquinone-based or thioxanthone-based compounds such as 2-ethylanthraquinone, 2-isopropylthioxanthone, 2-chlorothioxanthone, 2,4-dimethylthioxanthone, 2,4-diethylthioxanthone, and 2,4-dichlorothioxanthone.

Examples of other photopolymerization initiators include camphorquinone, 1-phenyl-1,2-propanedione-2-(o-ethoxycarbonyl)oxime, acridine-based compounds, triazine-based compounds, and imidazole-based compounds.

The photopolymerization initiator preferably has an absorption wavelength within the wavelength range of the light source used for light irradiation in order to efficiently absorb light energy to generate radicals. Among them, it is preferred to contain an acylphosphine oxide-based compound having an absorption wavelength on a relatively long wavelength side.

It is more preferred to use an acylphosphine oxide-based compound and a hydrogen abstraction type initiator in combination, from the viewpoint of complementing the curability of the surface of the protective layer. In this case, the content ratio of the hydrogen abstraction type initiator to the acylphosphine oxide-based compound is not particularly limited. It is preferably 0.1 part by mass or more relative to 1 part by mass of the acylphosphine oxide-based compound from the viewpoint of complementing the surface curability, and it is preferably 5 parts by mass or less from the viewpoint of maintaining the internal curability.

Materials having a photopolymerization promoting effect can be used alone or in combination with the above-mentioned photopolymerization initiator. Examples of the materials having a photopolymerization promoting effect include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

The polymerization initiator may be used alone or in a mixture of two or more types. The content of the polymerization initiator is preferably 0.5 to 40 parts by mass, more preferably 1 part by mass or more or 20 parts by mass or less, relative to 100 parts by mass of the total content having radical polymerizability.

The total content having radical polymerizability includes the electron transporting compound represented by the formula (1) and the curable compound.

### (Inorganic Particles)

The present protective layer may contain inorganic particles from the viewpoint of improving the strong exposure properties and mechanical strength, or from the viewpoint of imparting charge transport capability. However, it may not contain inorganic particles.

Examples of the inorganic particles include metal powder, metal oxide, metal fluoride, potassium titanate, and boron nitride, and in general, any inorganic particles that can be used for electrophotographic photoconductors can be used.

The inorganic particles may be used alone or in a mixture of a plurality of types.

### (Other Materials)

The present protective layer may contain other materials as necessary. Examples of the other materials include stabilizers (such as a heat stabilizer, ultraviolet absorber, light stabilizer, and antioxidant), dispersants, antistatic agents, colorants, and lubricants. These materials may be appropriately used alone or in any combination of two or more types in any ratio.

### (Method for Forming Present Protective Layer)

### [Protective Layer-Forming Coating Liquid]

The present protective layer can be formed, for example, by coating a coating liquid (referred to as “the present protective layer-forming coating liquid”), in which a curable composition containing an electron donating compound and optionally an electron transporting compound, a curable compound, a polymerization initiator, inorganic particles, and other materials are dissolved in a solvent or dispersed in a dispersion medium, onto the present photosensitive layer, and then curing the coating liquid. However, it is not limited to such a method.

When the electron transporting compound has a chain polymerizable functional group such as an acrylamide group, a methacrylamide group, an acryloyl group, or a methacryloyl group, it can also function as a curable compound. In this case, it is not necessary to contain a curable compound in addition to the electron transporting compound having a chain polymerizable functional group. Even when no curable compound is contained or the content of the curable compound is small, the use of the electron transporting compound having a chain polymerizable functional group provides sufficient mechanical strength of the protective layer and suppresses deterioration of the residual potential due to the presence of the curable compound. However, this does not preclude the use of a combination of the electron transporting compound having a chain polymerizable functional group and the curable compound.

The electron donating compound used in the present protective layer-forming coating liquid is preferably a compound represented by the formula (2) or (3).

The electron transporting compound used in the present protective layer-forming coating liquid is preferably a compound represented by the formula (1).

The preferred embodiments of the curable compound, polymerization initiator, inorganic particles, and other materials used in the present protective layer-forming coating liquid are the same as those of the materials used in the present protective layer.

The content ratio of the electron donating compound to the electron transporting compound (electron donating compound/electron transporting compound) in the present protective layer-forming coating liquid is the same as the content mass ratio of the electron donating compound to the electron transporting compound (electron donating compound/electron transporting compound) in the protective layer described above.

The content ratio of the curable compound to the electron donating compound (curable compound/electron donating compound) in the present protective layer-forming coating liquid is the same as the content mass ratio of the curable compound to the electron donating compound (curable compound/electron donating compound) in the protective layer described above.

The content ratio of the curable compound to the electron transporting compound (curable compound/electron transporting compound) in the present protective layer-forming coating liquid is the same as the content mass ratio of the curable compound to the electron transporting compound (curable compound/electron transporting compound) in the protective layer described above.

The content of the electron donating compound in the present protective layer-forming coating liquid is preferably 0.06 part by mass or more, more preferably 0.10 part by mass or more, and even more preferably 0.14 part by mass or more, relative to 100 parts by mass of the solvent, from the viewpoint of electrical properties. From the viewpoint of solubility, it is preferably 1.30 parts by mass or less, more preferably 1.00 part by mass or less, and even more preferably 0.70 part by mass or less, relative to 100 parts by mass of the solvent.

The content of the electron transporting compound in the present protective layer-forming coating liquid is preferably 4 parts by mass or more, more preferably 6 parts by mass or more, and even more preferably 8 parts by mass or more, relative to 100 parts by mass of the solvent, from the viewpoint of film uniformity of the protective layer. From the viewpoint of solubility, it is preferably 14 parts by mass or less, more preferably 12 parts by mass or less, and even more preferably 10 parts by mass or less, relative to 100 parts by mass of the solvent.

The content of the curable compound in the present protective layer-forming coating liquid is preferably 1 part by mass or more, more preferably 2 parts by mass or more, and even more preferably 4 parts by mass or more, relative to 100 parts by mass of the solvent, from the viewpoint of film uniformity of the protective layer. From the viewpoint of solubility, it is preferably 10 parts by mass or less, more preferably 8 parts by mass or less, and even more preferably 6 parts by mass or less, relative to 100 parts by mass of the solvent.

In particular, when the electron transporting compound contained in the present protective layer-forming coating liquid has a chain polymerizable functional group, the content of the curable compound in the present protective layer-forming coating liquid is preferably 10 parts by mass or less, more preferably 5 parts by mass or less, and even more preferably 0 part by mass, relative to 100 parts by mass of the solvent, from the viewpoint of residual potential.

As the solvent used in the present protective layer-forming coating liquid, for example, an organic solvent can be used. Examples of the organic solvent include: alcohols such as methanol, ethanol, propanol, and 2-methoxyethanol; ethers such as tetrahydrofuran, 1,4-dioxane, and dimethoxyethane; esters such as methyl formate and ethyl acetate; ketones such as acetone, methyl ethyl ketone, and cyclohexanone; aromatic hydrocarbons such as benzene, toluene, xylene, and anisole; chlorinated hydrocarbons such as dichloromethane, chloroform, 1,2-dichloroethane, 1,1,2-trichloroethane, 1,1,1-trichloroethane, tetrachloroethane, 1,2-dichloropropane, and trichloroethylene; nitrogen-containing compounds such as n-butylamine, isopropanolamine, diethylamine, triethanolamine, ethylenediamine, and triethylenediamine; and aprotic polar solvents such as acetonitrile, N-methylpyrrolidone, N,N-dimethylformamide, and dimethylsulfoxide. Mixed solvents of these can also be used in any combination and ratio. Among them, from the viewpoint of solubility and coatability, alcohols, ethers, aromatic hydrocarbons, and aprotic polar solvents are preferred; alcohols, ethers, and aromatic hydrocarbons are more preferred; alcohols and ethers are even more preferred; and alcohols are most preferred.

Even an organic solvent that alone does not dissolve the electron donating compound used in the protective layer of the present electrophotographic photoconductor can be used if it can be dissolved, for example, by mixing with the above-mentioned organic solvents. In general, the use of mixed solvents reduces coating unevenness. When an immersion coating method is used in the coating method described below, it is preferable to select a solvent that does not dissolve the underlying layer. From this point of view, it is particularly preferable to contain alcohols.

The amount ratio of the solvent used in the present protective layer-forming coating liquid to the solid content differs depending on the coating method of the protective layer-forming coating liquid, and may be changed and used as appropriate so as to form a uniform coating film in the coating method to be applied.

### [Coating Method]

The method for coating a coating liquid for forming the present protective layer is not particularly limited, and examples thereof include a spray coating method, a spiral coating method, a ring coating method, and an immersion coating method.

The above coating method is performed to form a coating film, and the coating film is then dried. The temperature and time of drying may be any as long as necessary and sufficient drying can be achieved. However, if the protective layer is formed only by air-drying after the photosensitive layer coating, it is preferable to perform sufficient drying by the method described in the method for forming a photosensitive layer described below.

### [Method for Curing Present Protective Layer]

The present protective layer can be formed by coating the present protective layer-forming coating liquid, and then curing the coating liquid by applying external energy. Examples of the external energy used in the curing include heat, light, and radiation.

Examples of the method for applying heat energy include heating methods using gases such as air and nitrogen, steam, various heat media, infrared rays, and electromagnetic waves. The heating can be applied from the coated surface side or the support side. The heating temperature is preferably 100° C. or higher and 170° C. or lower.

As for the light energy, an ultraviolet (UV) irradiation light source having a light emission wavelength mainly in UV light, such as a high-pressure mercury lamp, a metal halide lamp, an electrodeless lamp bulb, or a light emitting diode, can be used. In addition, a visible light source can also be selected according to an absorption wavelength of the chain polymerizable compound or the photopolymerization initiator.

The amount of light irradiation is preferably 10 J/cm² or more, more preferably 30 J/cm² or more, and particularly preferably 100 J/cm² or more, from the viewpoint of curability. In addition, it is preferably 500 J/cm² or less, more preferably 300 J/cm² or less, and particularly preferably 200 J/cm² or less, from the viewpoint of electrical properties.

Examples of the radiation energy include those using an electron beam (EB).

Among these energies, those using the light energy are preferred from the viewpoint ease of reaction rate control, simplicity of apparatus, and length of pot life.

After the protective layer is cured, a heating step may be added from the viewpoint of alleviating residual stress, alleviating residual radicals, and improving electrical properties. The heating temperature is preferably 60° C. or higher, more preferably 100° C. or higher; and preferably 200° C. or lower, more preferably 150° C. or lower.

### (Layer Thickness)

The thickness of the present protective layer is preferably 0.5 μm or more, more preferably 1 μm or more, from the viewpoint of abrasion resistance. In addition, it is preferably 5 μm or less, more preferably 3 μm or less, from the viewpoint of electrical properties.

From the same viewpoint, the thickness of the present protective layer is preferably 1/50 or more relative to the thickness of the present photosensitive layer, more preferably 1/40 or more, and even more preferably 1/30 or more. In addition, it is preferably ⅕ or less, more preferably 1/10 or less, and even more preferably 1/20 or less.

### <Present Photosensitive Layer>

The photosensitive layer (also referred to as “the present photosensitive layer”) in the present electrophotographic photoconductor may be a layer containing at least a charge generation material (CGM) and a charge transport material.

The present photosensitive layer may be a single-layered photosensitive layer containing a charge generation material and a charge transport material in the same layer, or a multi-layered photosensitive layer in which a charge generation layer and a charge transport layer are separated.

### <Single-Layered Photosensitive Layer>

The present photosensitive layer, when it is a single-layered photosensitive layer, preferably contains at least a charge generation material (CGM), a hole transport material (HTM), an electron transport material (ETM), and a binder resin in the same layer.

### (Charge Generation Material)

Examples of the charge generation material used in the present photosensitive layer include various photoconductive materials such as inorganic photoconductive materials and organic pigments. Among them, organic pigments are particularly preferred, and a phthalocyanine pigment and an azo pigment are more preferred.

Specifically, when a phthalocyanine pigment is used as the charge generation material, metal-free phthalocyanines and phthalocyanines coordinated with a metal such as copper, indium, gallium, tin, titanium, zinc, vanadium, silicon or germanium, or an oxide or halide thereof, are used. Among them, X-type and i-type metal-free phthalocyanines, A-type, B-type, and D-type titanyl phthalocyanines, vanadyl phthalocyanines, chloroindium phthalocyanines, chlorogallium phthalocyanines, and hydroxygallium phthalocyanines, which have high sensitivity, are particularly suitable.

When an azo pigment is used, various known bisazo pigments and trisazo pigments are suitably used.

The charge generation material may be used alone or in any combination of two or more types in any ratio. When two or more charge generation materials are used together, the charge generation materials to be used together may each be mixed afterwards, or they may be mixed together during the production and processing steps of the charge generation materials, such as synthesis, pigmentation, and crystallization.

The charge generation material preferably has a small particle diameter from the viewpoint of electrical properties. Specifically, the particle diameter of the charge generation material is preferably 1 μm or less, more preferably 0.5 μm or less. The lower limit thereof is 0.01 μm or more. The particle diameter of the charge generation material refers to a particle diameter in the state contained in the photosensitive layer.

The amount of the charge generation material in the single-layered photosensitive layer is preferably 0.1% by mass or more, more preferably 0.5% by mass or more, from the viewpoint of sensitivity. In addition, it is preferably 50% by mass or less, more preferably 20% by mass or less, from the viewpoint of sensitivity and chargeability.

### (Charge Transport Material)

The charge transport material is classified into a hole transport material mainly having hole transport capability and an electron transport material mainly having electron transport capability. The present photosensitive layer, when it is a single-layered photosensitive layer, preferably contains at least a hole transport material and an electron transport material in the same layer.

### [Hole Transport Material]

The hole transport material (HTM) can be selected from known materials. Examples thereof include electron donating materials, such as heterocyclic compounds such as a carbazole derivative, an indole derivative, an imidazole derivative, an oxazole derivative, a pyrazole derivative, a thiadiazole derivative, and a benzofuran derivative, an aniline derivative, a hydrazone derivative, an arylamine derivative, a stilbene derivative, a butadiene derivative, and an enamine derivative, a compound obtained by bonding a plurality of these compounds, and a polymer having a group derived from these compounds in a main chain or a side chain.

Among them, a carbazole derivative, an arylamine derivative, a stilbene derivative, a butadiene derivative, an enamine derivative, and a compound obtained by bonding a plurality of these compounds are preferred, and an arylamine derivative and an enamine derivative are more preferred.

The hole transport material may be used alone or in any combination of two or more types in any ratio.

The amount of the hole transport material in the single-layered photosensitive layer is preferably 20% by mass or more, more preferably 30% by mass or more, relative to 100% by mass of the entire present photosensitive layer, from the viewpoint of hole transportability. In addition, it is preferably 55% by mass or less, more preferably 45% by mass or less, from the viewpoint of solubility.

### [Electron Transport Material]

The electron transport material (ETM) can be selected from known materials. Examples thereof include: electron attracting materials, such as aromatic nitro compounds such as 2,4,7-trinitrofluorenone, cyano compounds such as tetracyanoquinodimethane, and quinone compounds such as diphenoquinone; and known cyclic ketone compounds and perylene pigments (perylene derivatives). Among them, quinone compounds and perylene pigments (perylene derivatives) are preferred, and quinone compounds are more preferred, from the viewpoint of electrical properties.

Among the quinone compounds, diphenoquinone and dinaphthylquinone are preferred from the viewpoint of electrical properties. Among them, dinaphthylquinone is more preferred.

The electron transport material may be used alone or in any combination of two or more types in any ratio.

The amount of the electron transport material in the single-layered photosensitive layer is preferably 15% by mass or more, more preferably 25% by mass or more, relative to 100% by mass of the entire present photosensitive layer, from the viewpoint of electron transportability. In addition, it is preferably 40% by mass or less, more preferably 30% by mass or less, from the viewpoint of solubility.

Preferred examples of the structure of the electron transport material are shown below.

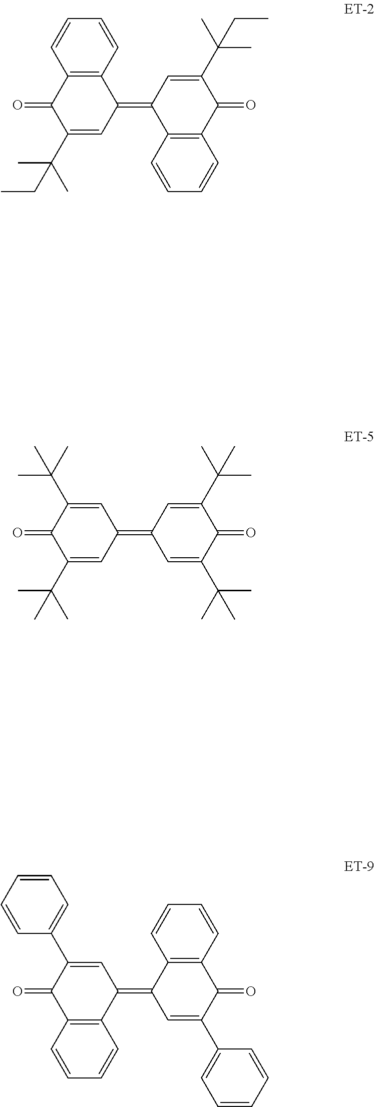 [SMILES: CCC(C)(C)C1=C/C(=C2/C=C(C(C)(C)CC)C(=O)c3ccccc32)c2ccccc2C1=O ; CC(C)(C)C1=CC(=C2C=C(C(C)(C)C)C(=O)C(C(C)(C)C)=C2)C=C(C(C)(C)C)C1=O ; O=C1C(c2ccccc2)=C/C(=C2/C=C(c3ccccc3)C(=O)c3ccccc32)c2ccccc21]

Among the above electron transport materials, ET-2 and ET-5 are preferred, and ET-2 is more preferred, from the viewpoint of electrical properties.

### (Binder Resin)

The following describes a binder resin used in the present photosensitive layer.

Examples of the binder resin used in the present photosensitive layer include: vinyl polymers such as polymethyl methacrylate, polystyrene, and polyvinyl chloride, or copolymers thereof; vinyl alcohol resins; polyvinyl butyral resins; polyvinyl formal resins; partially modified polyvinyl acetal resins; polyarylate resins; polyamide resins; polyurethane resins; polycarbonate resins; polyester resins; polyester carbonate resins; polyimide resins; phenoxy resins; epoxy resins; silicone resins; and partially-crosslinked cured product thereof. The above resins may each be modified with a silicon reagent or the like. These may be used alone or in any combination of two or more types in any ratio.

The binder resin used in the present photosensitive layer preferably contains one or two or more types of polymers obtained by interfacial polymerization.

As the binder resin obtained by interface polymerization, a polycarbonate resin and a polyester resin are preferred, and in particular, a polycarbonate resin or a polyarylate resin is preferred. In addition, a polymer obtained by using an aromatic diol as a raw material is particularly preferred.

### (Other Materials)

The present photosensitive layer may contain, in addition to the above-mentioned materials, known additives such as an antioxidant, a plasticizer, an ultraviolet absorber, an electron attracting compound, a leveling agent, and a visible light shielding agent, for improving film formability, flexibility, coating ability, contamination resistance, gas resistance, light resistance, and the like. The present photosensitive layer may also contain various additives such as a sensitizer, a dye, a pigment (excluding the charge generation material, the hole transport material, and the electron transport material described above), and a surfactant, as necessary. Examples of the surfactant include silicone oil and fluorine compounds. In the present invention, these may be appropriately used alone or in any combination of two or more types in any ratio.

For the purpose of reducing friction resistance on the surface of the photosensitive layer, the present photosensitive layer may contain a fluorine resin, a silicone resin, or the like, and may contain particles made of these resins or particles made of inorganic compounds such as aluminum oxide.

### (Layer Thickness)

When the present photosensitive layer is a single-layered photosensitive layer, the thickness of the present photosensitive layer is preferably 20 μm or more, more preferably 25 μm or more, from the viewpoint of dielectric breakdown resistance. In addition, it is preferably 50 μm or less, more preferably 40 μm or less, from the viewpoint of electrical properties.

### <Multi-Layered Photosensitive Layer>

When the present electrophotographic photoconductor has a multi-layered photosensitive layer, examples of the configuration thereof include a configuration in which a charge transport layer (CTL) containing a charge transport material is laminated on a charge generation layer (CGL) containing a charge generation material (CGM). In this case, the multi-layered photosensitive layer may also include any layer other than the charge generation layer (CGL) and the charge transport layer (CTL).

### <Charge Generation Layer (CGL)>

The charge generation layer generally contains a charge generation material (CGM) and a binder resin.

The charge generation material (CGM) and the binder resin are the same as in the single-layered photosensitive layer described above.

### (Other Components)

The charge generation layer may contain other components in addition to the charge generation material and the binder resin, as necessary. For example, the charge generation layer may contain known additives such as an antioxidant, a plasticizer, an ultraviolet absorber, an electron attracting compound, a leveling agent, a visible light shielding agent, and a filler, for the purpose of improving film formability, flexibility, coating ability, contamination resistance, gas resistance, light resistance, and the like.

### (Blending Ratio)

In the charge generation layer, if the ratio of the charge generation material is too high, the stability of the coating liquid may be decreased due to aggregation and the like of the charge generation material, while if the ratio of the charge generation material is too low, the sensitivity of the photoconductor may be decreased. Therefore, as for the blending ratio (mass) of the binder resin and the charge generation material, the charge generation material is preferably contained in an amount of 10 parts by mass or more, more preferably 30 parts by mass or more, relative to 100 parts by mass of the binder resin; and preferably 1,000 parts by mass or less, more preferably 500 parts by mass or less, even more preferably 300 parts by mass or less from the viewpoint of film strength, and still more preferably 200 parts by mass or less.

### (Layer Thickness)

The thickness of the charge generation layer is preferably 0.1 μm or more, more preferably 0.15 μm or more. In addition, it is preferably 10 μm or less, more preferably 0.6 μm or less.

### <Charge Transport Layer (CTL)>

The charge transport layer (CTL) generally contains a charge transport material and a binder resin.

The charge transport material and the binder resin are the same as in the single-layered photosensitive layer described above.

As for the blending ratio of the binder resin and the hole transport material (HTM) in the charge transport layer (CTL), the hole transport material (HTM) is preferably contained in an amount of 20 parts by mass or more, more preferably 30 parts by mass or more from the viewpoint of reducing residual potential, and even more preferably 40 parts by mass or more from the viewpoint of stability in repeated use and degree of charge transfer, relative to 100 parts by mass of the binder resin. In addition, the hole transport material (HTM) is preferably contained in an amount of 200 parts by mass or less from the viewpoint of thermal stability of the photosensitive layer, more preferably 150 parts by mass or less from the viewpoint of compatibility of the hole transport material (HTM) and the binder resin, and even more preferably 120 parts by mass or less from the viewpoint of glass transition temperature, relative to 100 parts by mass of the binder resin.

### (Other Components)

The charge transport layer may contain other components in addition to the electron transport material (ETM), the hole transport material (HTM), and the binder resin, as necessary. For example, the charge transport layer may contain known additives such as an antioxidant, a plasticizer, an ultraviolet absorber, an electron attracting compound, a leveling agent, a visible light shielding agent, and a filler, for the purpose of improving film formability, flexibility, coating ability, contamination resistance, gas resistance, light resistance, and the like.

### (Layer Thickness)

The thickness of the charge transport layer is not particularly limited. It is preferably 5 μm or more and 50 μm or less, more preferably 10 μm or more or 35 μm or less, and even more preferably 15 μm or more or 25 μm or less, from the viewpoint of electrical properties, image stability, and high image resolution.

### <Method for Forming Photosensitive Layer>

In both the multi-layer and single-layer types, each of the layers can be formed as follows.

Materials to be contained are dissolved or dispersed in a solvent to obtain a coating liquid, the coating liquid is coated on a conductive support by a known method, such as immersion coating, spray coating, nozzle coating, bar coating, roll coating, or blade coating, and the coating and drying steps are sequentially repeated for each layer, thereby forming layers.

However, it is not limited to this formation method.

The solvent or dispersion medium used for the preparation of the coating liquid is not particularly limited. Specific examples thereof include alcohols, ethers, aromatic hydrocarbons, and chlorinated hydrocarbons. These may be used alone or in any combination of two or more types in any type.

The amount of the solvent or dispersion medium used is not particularly limited. In view of the use purpose of each layer and properties of the solvent or dispersion medium selected, it is preferable to adjust the amount appropriately such that the physical properties of the coating liquid, such as solid content concentration and viscosity, are within the desired range.

As for the drying of the coating film, the coating film is preferably touch-dried at room temperature, and then heat-dried at a temperature range of generally 30° C. or higher and 200° C. or lower for 1 minute to 2 hours at a standstill or under air flow. The heating temperature may be constant, or the temperature may be varied during the heat drying.

### <Present Conductive Support>

The conductive support in the present electrophotographic photoconductor (also referred to as “the present conductive support”) is not particularly limited as long as it supports layers formed thereon and exhibits conductivity.

Examples of the present conductive support mainly used include: metal materials such as aluminum, aluminum alloy, stainless steel, copper, and nickel; resin materials with conductivity added by coexisting conductive powders of metal, carbon, and tin oxide; and resin, glass, and paper having conductive materials such as aluminum, nickel, and ITO (indium tin oxide alloy) vapor-deposited or coated on their surfaces.

The present conductive support used may be in the form of a drum, cylinder, sheet, belt, or the like.

The present conductive support may be a conductive support made of a metal material with a conductive material having a suitable resistance value coated thereon for controlling conductivity, surface properties, and the like, and for covering defects.

When a metal material such as an aluminum alloy is used as the present conductive support, the metal material may be coated with an anodic oxide film.

The average thickness of the anodic oxide film is preferably 20 μm or less, particularly preferably 7 μm or less.

The metal material, when coated with an anodic oxide film, is preferably subjected to a sealing treatment. The sealing treatment can be performed by a known method.

The surface of the present conductive support may be smooth or roughened by a special cutting method or polishing treatment. The surface may also be roughened by mixing particles having an appropriate particle diameter with the materials constituting the support.

In order to improve adhesion, blocking tendency, and the like, an undercoat layer described below may be provided between the present conductive support and the photosensitive layer.

### <Present Undercoat Layer>

The present electrophotographic photoconductor may include an undercoat layer (also referred to as “the present undercoat layer”) between the present photosensitive layer and the present conductive support.

Examples of the material used in the present undercoat layer include a resin and a resin having particles of organic pigments, metal oxides, or the like dispersed therein.

Examples of the organic pigments used in the undercoat layer include phthalocyanine pigments, azo pigments, and perylene pigments. In particular, phthalocyanine pigments and azo pigments, specifically the phthalocyanine pigment and the azo pigment as used as the charge generation material described above, can be exemplified.

Examples of the metal oxide particles used in the present undercoat layer include: metal oxide particles containing one metal element such as titanium oxide, aluminum oxide, silicon oxide, zirconium oxide, zinc oxide, or iron oxide; and metal oxide particles containing multiple metal elements such as calcium titanate, strontium titanate, and barium titanate. In the undercoat layer, only one type of particles may be used, or multiple types of particles may be used in mixture in any ratio and combination.

Among the above metal oxide particles, titanium oxide and aluminum oxide are preferred, and titanium oxide is particularly preferred.

The particle diameter of the metal oxide particles used in the present undercoat layer is not particularly limited. The average primary particle diameter is preferably 10 nm or more, and preferably 100 nm or less, more preferably 50 nm or less, from the viewpoint of properties of the undercoat layer and stability of the solution for forming the undercoat layer.

The binder resin used in the present undercoat layer can be selected and used, for example, from: polyvinyl acetal resins such as polyvinyl butyral resin; and insulating resins such as polyarylate resin, polycarbonate resin, polyester resin, phenoxy resin, acrylic resin, methacrylic resin, polyamide resin, polyurethane resin, epoxy resin, silicone resin, polyvinyl alcohol resin, and styrene-alkyd resin. However, it is not limited to these polymers. These binder resins may be used alone or in a mixture of two or more types, or may be used in a cured form with a curing agent.

Among them, polyvinyl acetal resins, alcohol-soluble copolymerized polyamides, modified polyamides, and the like are preferred because of their good dispersibility and coating ability. Among them, alcohol-soluble copolymerized polyamides are particularly preferred.

The mixing ratio of the particles to the binder resin can be arbitrarily selected. The ratio is preferably in a range of 10% by mass to 500% by mass from the viewpoint of stability and coating ability of the dispersion.

The film thickness of the present undercoat layer can be arbitrarily selected. The film thickness is preferably 0.1 μm or more, more preferably 20 μm or less, from the viewpoint of properties of the electrophotographic photoconductor and coating ability of the dispersion. The undercoat layer may contain a known antioxidant or the like.

### <Other Layers>

The present electrophotographic photoconductor may appropriately include other layers, as necessary, in addition to the present conductive support, the present photosensitive layer, the present protective layer, and the present undercoat layer described above.

### <<Present Image Formation Device>>

The present electrophotographic photoconductor can be used to configure an image formation device (also referred to as “the present image formation device”).

The present image formation device described below is an example of an image formation device that can be configured using the present electrophotographic photoconductor, and the present invention is not limited to the present image formation device.

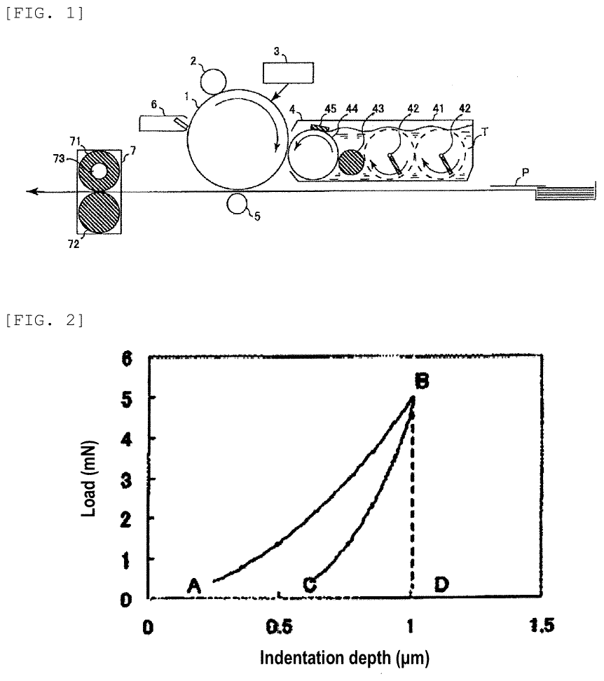

As shown in FIG. 1, the present image formation device includes a present electrophotographic photoconductor 1, a charging device 2, an exposing device 3, and a developing device 4, and may further include a transferring device 5, a cleaning device 6, and a fixing device 7, as necessary.

The present electrophotographic photoconductor 1 is not particularly limited as long as it is the present electrophotographic photoconductor described above. FIG. 1 shows, as one example thereof, a drum-shaped photoconductor including the photosensitive layer described above formed on the surface of a cylindrical conductive support. Along the outer peripheral surface of the present electrophotographic photoconductor 1, the charging device 2, the exposing device 3, the developing device 4, the transferring device 5, and the cleaning device 6 are disposed.

Examples of the charging device 2 include non-contact type corona charging devices such as corotron and scorotron, and contact type charging devices (direct type charging devices) that charge the photoconductor by bringing a voltage-applied charging member into contact with the surface of the photoconductor. Examples of the contact type charging devices include a charging roller and a charging brush. FIG. 1 shows a roller type charging device (charging roller) as one example of the charging device 2.

The type of the exposing device 3 is not particularly limited as long as the exposing device exposes the present electrophotographic photoconductor 1 to form an electrostatic latent image on the photosensitive surface of the present electrophotographic photoconductor 1.

The exposure may be performed by an internal exposure system of the photoconductor. The light used for exposure is arbitrary.

The type of a toner T is arbitrary, and may be a powder toner, a polymerized toner using a suspension polymerization method or an emulsion polymerization method, or the like.

The configuration of the developing device 4 is also arbitrary. The developing device 4 shown in FIG. 1 has a configuration in which the toner T is thinned by a regulating member (developing blade) 45, frictionally charged to a predetermined polarity, and brought into contact with the surface of the photoconductor 1 while being conveyed by being carried on a developing roller 44. However, it is not limited to this configuration.

The type of the transferring device 5 is not particularly limited, and may be a device using any method, such as an electrostatic transferring method such as corona transfer, roller transfer, or belt transfer, a pressure transferring method, or an adhesive transferring method.

The cleaning device 6 is not particularly limited. For example, any cleaning device such as a brush cleaner, a magnetic roller cleaner, or a blade cleaner can be used. If there is little or almost no toner remaining on the surface of the photoconductor, no cleaning device 6 may be used.

The configuration of the fixing device 7 is also arbitrary.

The image formation device may have a configuration capable of performing, for example, a static elimination step, in addition to the configurations described above.

In addition, the image formation device may have a configuration with further modifications, such as a configuration capable of performing steps such as a pre-exposure step and an auxiliary charging step, a configuration capable of performing offset printing, or a configuration of a full color tandem system using multiple toners.

### <<Present Electrophotographic Photoconductor Cartridge>>

The present electrophotographic photoconductor 1 can be used in combination with one or two or more of the charging device 2, the exposing device 3, the developing device 4, the transferring device 5, the cleaning device 6, and the fixing device 7, to thereby configure an integrated type cartridge (referred to as “the present electrophotographic photoconductor cartridge”).

The present electrophotographic photoconductor cartridge described below is an example of an electrophotographic photoconductor cartridge that can be configured using the present electrophotographic photoconductor, and the present invention is not limited to the present electrophotographic photoconductor cartridge.

The present electrophotographic photoconductor cartridge may have a configuration capable of being attached to or detached from an electrophotographic device main body, such as a copier or a laser beam printer. In this case, for example, when the present electrophotographic photoconductor 1 or other members are deteriorated, the image formation device is capable of detaching the electrophotographic photoconductor cartridge from the image formation device main body and attaching another new electrophotographic photoconductor cartridge thereto, thereby facilitating maintenance and management of the image formation device.

### <<Explanation of Terms and Phrases>>

In the present invention, the expression “from X to Y” (wherein X and Y each represent an arbitrary numeral) encompasses the meaning “X or more and Y or less” and also encompasses the meaning “preferably more than X” or “preferably less than Y”, unless otherwise indicated.

The expression “X or more” (wherein X represents an arbitrary numeral) or “Y or less” (wherein Y represents an arbitrary numeral) encompasses the meaning “preferably more than X” or “preferably less than Y”.

In the present specification, the term “preferably” encompasses the meaning of “not necessarily essential, but better to be essential”.

In the present specification, the term “or” means “and/or”.

### EXAMPLES

Embodiments of the present invention are further specifically described below with reference to Examples. However, the following Examples are shown for the purpose of explaining the present invention in detail and the present invention is not to be limited to the following Examples without departing from the gist thereof, and may be implemented with any modification. The term “parts” in the following Examples and Comparative Examples refers to “parts by mass” unless otherwise specified.

In the present specification, the term DMF means N,N-dimethylformamide and the term MEHQ means 4-methoxyphenol.

### <Synthesis of Electron Transporting Compounds>

The synthesis methods of electron transporting compounds 1 to 3 are described below.

### [Synthesis of Electron Transporting Compound 1]

The following describes the synthesis scheme of the electron transporting compound 1 shown in the structural formula below.

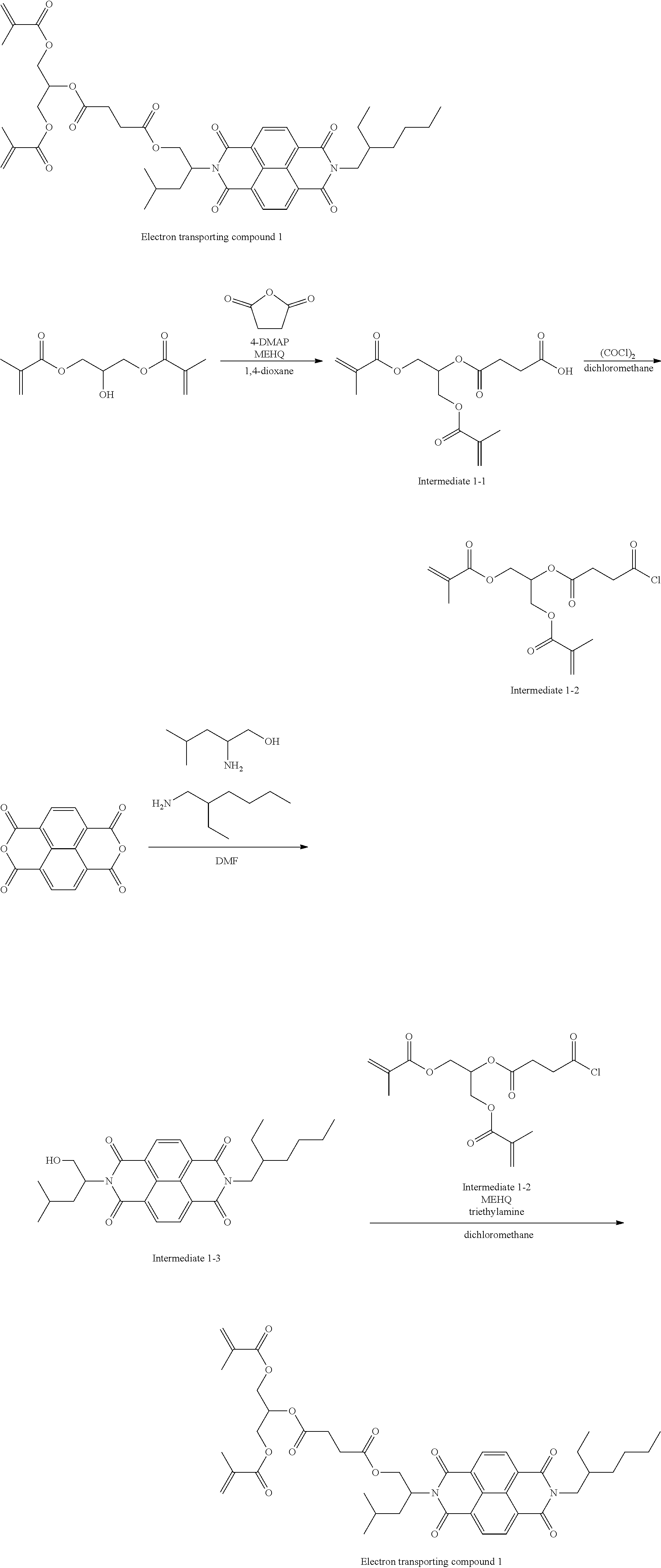

The following describes the synthesis procedure of the electron transporting compound 1.

### Synthesis of Intermediate 1-1

Under a nitrogen atmosphere, 100 mL of 1,4-dioxane was added to a mixture of succinic anhydride (11.0 g, 109.5 mmol) and 4-DMAP (4-dimethylaminopyridine, 0.26 g, 2.19 mmol) to prepare a solution. To the solution, a solution obtained by mixing glycerol dimethacrylate (25 g, 109.5 mmol) dissolved in 50 mL of 1,4-dioxane with MEHQ (27 mg, 0.22 mmol) was added dropwise, and the resulting solution was stirred at 80° C. for 9 hours. After cooling to room temperature, the resulting solution was poured into 200 mL of water and extracted with dichloromethane, and the organic layer was washed with water and then dried over magnesium sulfate. The resulting solid was filtered, the solvent in the filtrate was distilled off under reduced pressure, and the residue was dried to obtain an intermediate 1-1 (yield: 30 g, yield rate: 83% by mass).

### Synthesis of Intermediate 1-2

Under a nitrogen atmosphere, 100 mL of dehydrated dichloromethane and 1 mL of dehydrated dimethylformamide were added to the intermediate 1-1 (21.6 g, 65.8 mmol) to prepare a solution, and the solution was ice-cooled. Oxalyl chloride (11.2 mL, 131.6 mmol) was added dropwise thereto, and the resulting solution was stirred under ice cooling for 2 hours and then stirred at room temperature for 12 hours. The solvent was distilled off under reduced pressure, and the residue was dried to obtain an intermediate 1-2 (yield: 21.5 g, yield rate: 94% by mass).

### Synthesis of Intermediate 1-3

Under a nitrogen atmosphere, 60 mL of N,N-dimethylformamide was added to naphthalene-1,4,5,8-tetracarboxylic dianhydride (7.18 g, 26.8 mmol) to prepare a solution. To the solution, a solution obtained by mixing L-(+)-leucinol (4.71 g, 40.2 mmol) dissolved in 40 mL of N,N-dimethylformamide with 2-ethylhexylamine (5.19 g, 40.2 mmol) was added dropwise, and the resulting solution was stirred at 120° C. for 8 hours. After cooling to room temperature, the resulting solution was poured into 200 mL of ice water, and 1 N hydrochloric acid was added thereto to acidify the reaction solution. After extraction with dichloromethane, the organic layer was washed with water and then dried over magnesium sulfate, and the resulting solid was filtered. The solvent in the filtrate was distilled off under reduced pressure, and the residue was dried to obtain an intermediate 1-3 (yield: 10.7 g, yield rate: 84% by mass).

### (Synthesis of Electron Transporting Compound 1)

Under a nitrogen atmosphere, 150 mL of dehydrated dichloromethane and triethylamine (11.7 mL, 84.4 mmol) were added to a mixture of the intermediate 1-3 (10.1 g, 21.1 mmol) and 4-methoxyphenol (0.01 g) to prepare a solution, and the solution was ice-cooled. To the solution, the intermediate 1-2 (14.6 g, 42.2 mmol) dissolved in 50 mL of dehydrated dichloromethane was added dropwise, and the resulting solution was stirred under ice cooling for 1 hour and then stirred at room temperature for 12 hours. The reaction solution was poured into 100 mL of water and extracted with dichloromethane, and the organic layer was washed with water and then dried over magnesium sulfate. The resulting solid was filtered, the solvent in the filtrate was distilled off under reduced pressure, and the residue was subjected to silica gel column chromatography to obtain an electron transporting compound 1 (yield: 5.3 g, yield rate: 32% by mass).

### [Synthesis of Electron Transporting Compound 2]

The following describes the synthesis scheme of the electron transporting compound 2 shown in the structural formula below. The electron transporting compound 2 is a mixture of an electron transporting compound 2-a and an electron transporting compound 2-b.

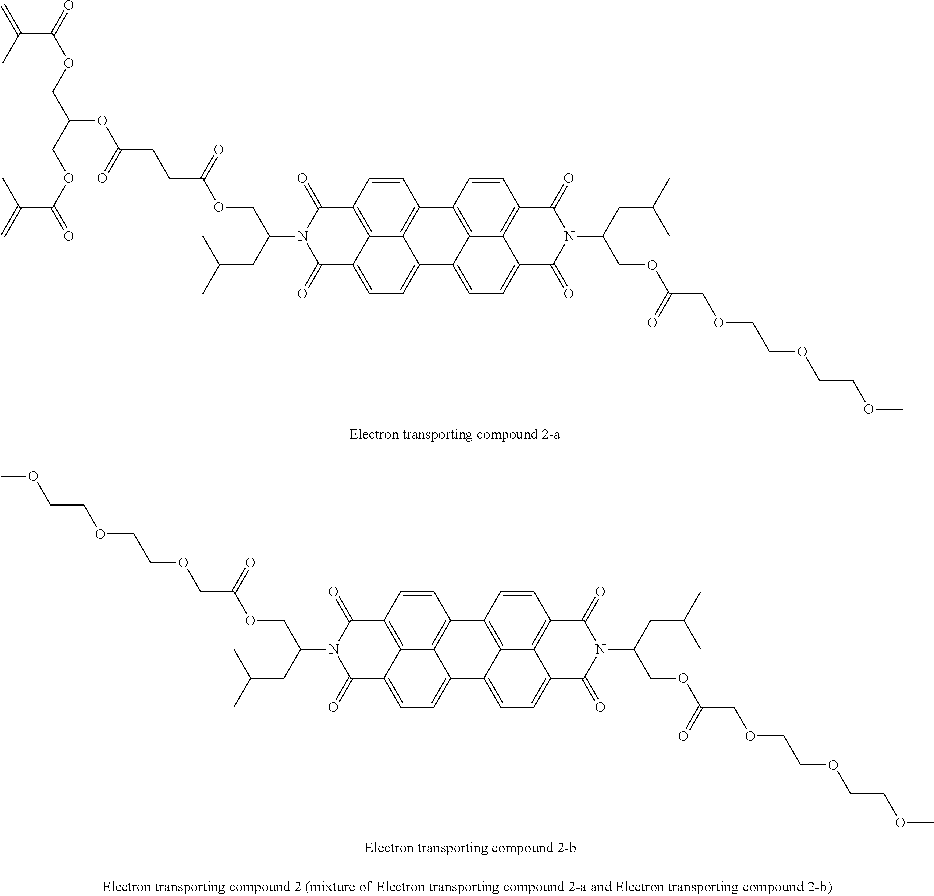

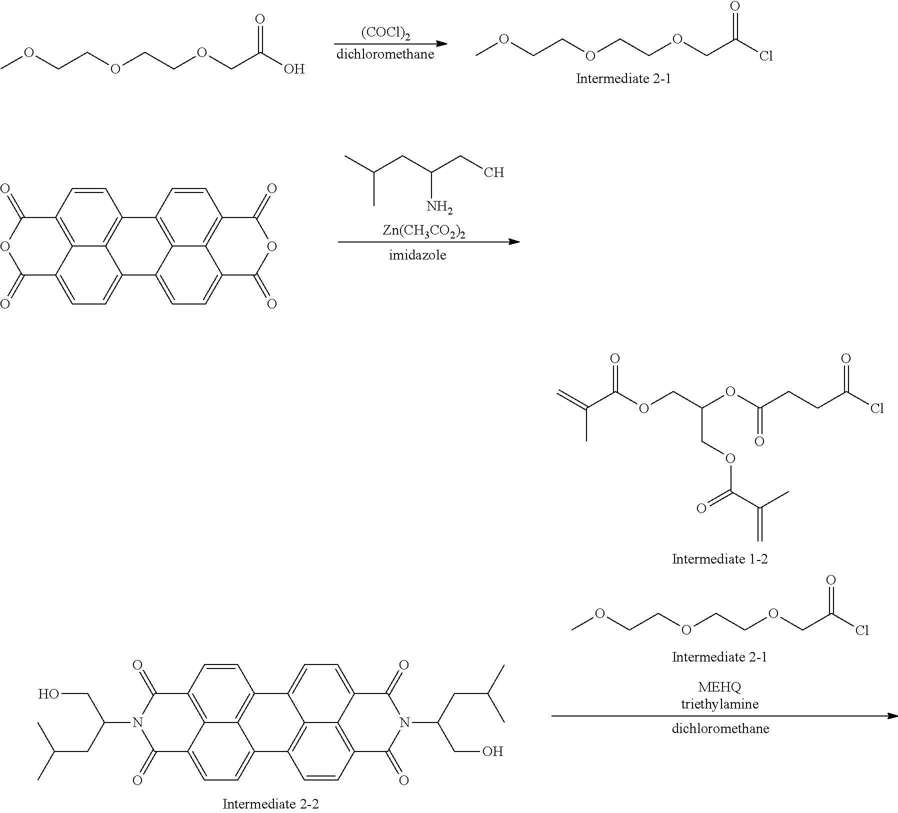

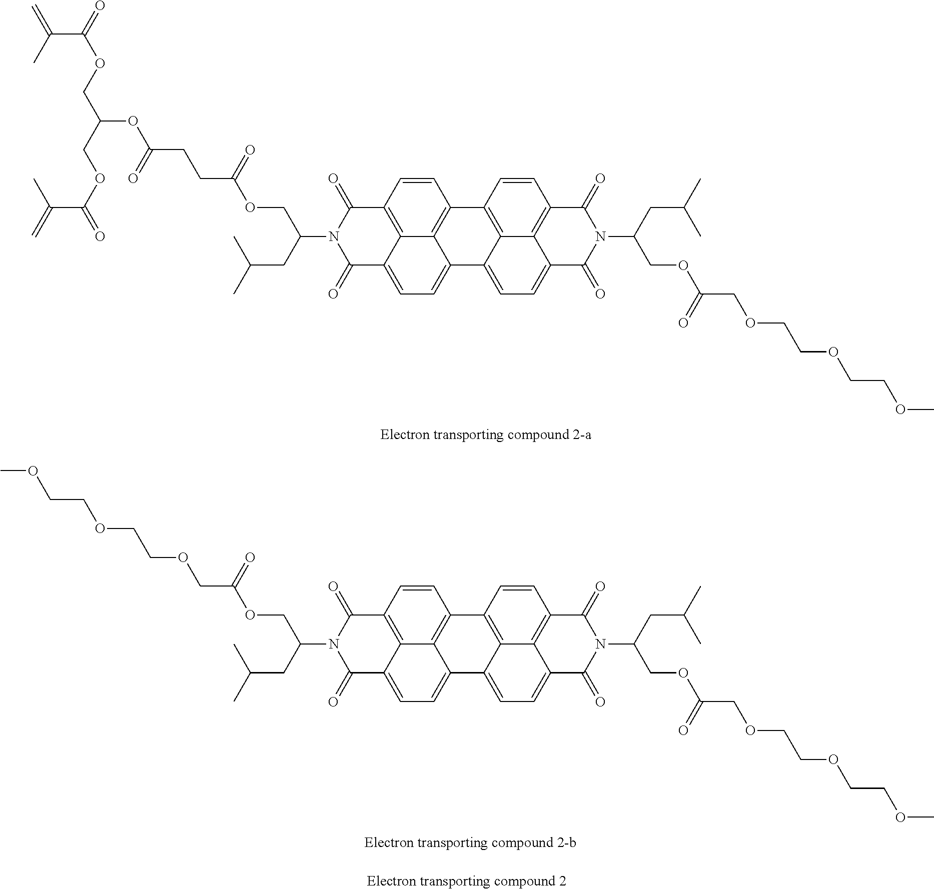

The following describes the synthesis procedure of the electron transporting compound 2.

### Synthesis of Intermediate 2-1

Under a nitrogen atmosphere, 100 mL of dehydrated dichloromethane was added to [2-(2-methoxyethoxy)ethoxy]acetic acid (6.3 g, 35.3 mmol) to prepare a solution, and the solution was ice-cooled. To the solution, 0.5 mL of N,N-dimethylformamide was added, then oxalyl chloride (6.1 mL, 70.7 mmol) was added dropwise, and the resulting solution was stirred under ice cooling for 1 hour and then stirred at room temperature for 12 hours. The solvent was distilled off under reduced pressure, and the residue was dried to obtain an intermediate 2-1 (yield: 6.9 g, yield rate: 99% by mass).

### Synthesis of Intermediate 2-2

Under a nitrogen atmosphere, 3,4,9,10-perylene tetracarboxylic dianhydride (11.4 g, 29.0 mmol), zinc acetate (5.32 g, 29.0 mmol), 50 g of imidazole, and L-(+)-leucinol (8.5 g, 72.5 mmol) were mixed, and the mixture was stirred at 160° C. for 7 hours. After cooling to room temperature, the mixture was dissolved in dichloromethane, the resulting solution was poured into 200 mL of ice water, and 1 N hydrochloric acid was added thereto to acidify the reaction solution. After extraction with dichloromethane, the organic layer was washed with water and then dried over magnesium sulfate. The resulting solid was filtered, the solvent in the filtrate was distilled off under reduced pressure, and the residue was subjected to silica gel column chromatography to obtain an intermediate 2-2 (yield: 12.0 g, yield rate: 70% by mass).

### (Synthesis of Electron Transporting Compound 2)

Under a nitrogen atmosphere, 200 mL of dehydrated dichloromethane and triethylamine (19.5 mL, 141 mmol) were added to a mixture of the intermediate 2-2 (13.9 g, 23.5 mmol) and 4-methoxyphenol (0.04 g) to prepare a solution, and the solution was ice-cooled. To the solution, the intermediate 2-1 (12.2 g, 35.3 mmol) and the intermediate 1-2 (6.94 g, 35.3 mmol) dissolved in 80 mL of dehydrated dichloromethane were added dropwise, and the resulting solution was stirred under ice cooling for 1 hour and then stirred at room temperature for 12 hours. The solvent in the reaction solution was distilled off under reduced pressure, and the residue was subjected to silica gel column chromatography to obtain an electron transporting compound 2 (yield: 22 g, yield rate: 88% by mass, molar ratio of electron transporting compound 2-a and electron transporting compound 2-b (2-a:2-b)=2:1).

### [Synthesis of Electron Transporting Compound 3]

The following describes the synthesis scheme of the electron transporting compound 3 shown in the structural formula below.

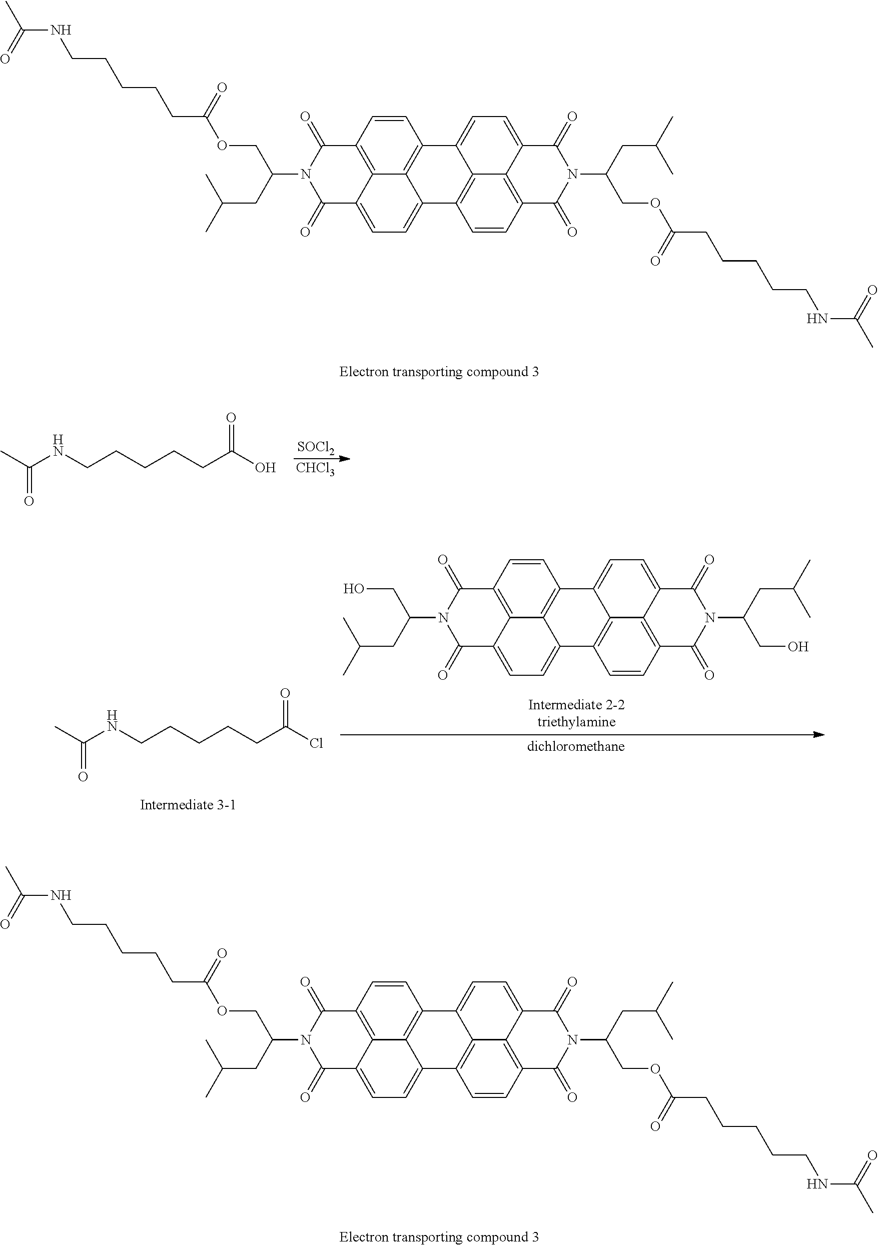

The following describes the synthesis procedure of the electron transporting compound 3.

### Synthesis of Intermediate 3-1

Under a nitrogen atmosphere, 60 mL of dehydrated chloroform was added to 6-acetamidohexanoic acid (7.8 g, 45.0 mmol) to prepare a solution, and the solution was ice-cooled. To the solution, thionyl chloride (3.3 mL, 45.0 mmol) was added dropwise, and the resulting solution was stirred under ice cooling for 30 minutes and then stirred at 60° C. for 1 hour. After cooling to room temperature, the solvent was distilled off under reduced pressure, and the residue was dried to obtain an intermediate 3-1 (yield: 8.5 g, yield rate: 98% by mass).

### (Synthesis of Electron Transporting Compound 3)

Under a nitrogen atmosphere, 60 mL of dehydrated dichloromethane and triethylamine (6.1 mL, 43.8 mmol) were added to the intermediate 2-2 (4.3 g, 7.3 mmol) to prepare a solution, and the solution was ice-cooled. To the solution, the intermediate 3-1 (4.2 g, 21.9 mmol) dissolved in 30 mL of dehydrated dichloromethane was added dropwise, and the resulting solution was stirred under ice cooling for 30 minutes and then stirred at room temperature for 12 hours. The solvent in the reaction solution was distilled off under reduced pressure, and the residue was subjected to silica gel column chromatography to obtain an electron transporting compound 3 (yield: 2.5 g, yield rate: 38% by mass).

### <Electron Donating Compound 1>

For the electron donating compound 1 having a structure shown in the structural formula below, a product manufactured by Merck/Millipore-Sigma was used.

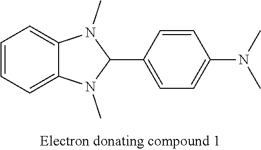 [SMILES: CN(C)c1ccc(C2N(C)c3ccccc3N2C)cc1]

### <Electron Donating Compound 2>

The electron donating compound 2 shown in the structural formula below was synthesized according to the method described in the Supplementary Information, page 2, line 18 to page 2, line 27 of the non-patent literature (Mater. Chem. Front., 2020, 4, 3616).

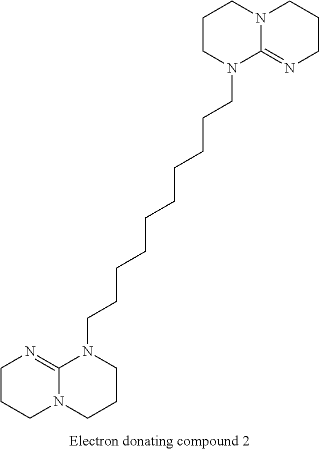 [SMILES: C(CCCCCN1CCCN2CCCN=C12)CCCCN1CCCN2CCCN=C12]

### <Production of Electrophotographic Photoconductor>

### (Preparation of Undercoat Layer-Forming Coating Liquid P1)

Twenty parts of D-type titanyl phthalocyanine showing a clear peak at a diffraction angle of 2θ=27.3°±0.2° in powder X-ray diffraction using CuKα rays, and 280 parts of 1,2-dimethoxyethane were mixed and ground for 2 hours using a sand grind mill for atomization dispersion treatment. To the mixture, 400 parts of a 1,2-dimethoxyethane solution containing 2.5% by mass of polyvinyl butyral (trade name “Denka butyral” #6000C, manufactured by Denka Company Limited) and 170 parts of 1,2-dimethoxyethane were further added and mixed, thereby preparing an undercoat layer-forming coating liquid P1 having a solid content concentration of 3.4% by mass.

### (Preparation of Single-Layered Photosensitive Layer-Forming Coating Liquid Q1)

To 793.35 parts of a mixed solvent of tetrahydrofuran (hereinafter appropriately abbreviated as THF) and toluene (hereinafter appropriately abbreviated as TL) (THF: 80% by mass, TL: 20% by mass), 2.6 parts of D-type titanyl phthalocyanine showing a clear peak at a diffraction angle of 2θ=27.3°±0.2° in powder X-ray diffraction using CuKα rays, 1.3 parts of a perylene pigment 1 having the following structure, 0.5 part of a polyvinyl butyral resin, 100 parts of the following hole transport material (HTM48, molecular weight of 748), 60 parts of the following electron transport material (ET-2, molecular weight of 424.2), 100 parts of a polycarbonate resin having a biphenyl structure, and 0.05 part of a silicone oil (tradename: KF-96, manufactured by Shin-Etsu Chemical Co., Ltd.) as a leveling agent were added and mixed, thereby preparing a single-layered photosensitive layer-forming coating liquid Q1 having a solid content concentration of 25% by mass.

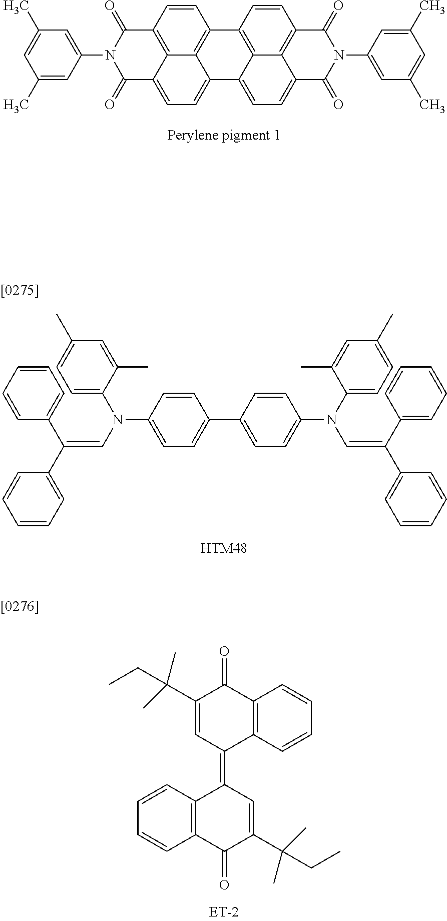

### (Preparation of Protective Layer-Forming Coating Liquid S1)

A curable compound (polyester acrylate: product name “Aronix M-9050”, manufactured by Toagosei Co., Ltd.) previously dissolved in a mixed solvent of toluene and 2-propanol, Omnirad TPO H (2,4,6-trimethylbenzoyl-diphenyl phosphine oxide) and benzophenone (BP) as polymerization initiators, the electron transporting compound 1, and the electron donating compound 1 were mixed to prepare a protective layer-forming coating liquid S1 (solid content concentration of approximately 8% by mass) in which the mass ratio of electron transporting compound/M-9050/electron donating compound/TPO+BP was 100/50/2.5/9 and the mass ratio of the solvent composition of toluene/2-propanol was 3/7.

### (Preparation of Protective Layer-Forming Coating Liquids S2 to S16)

Protective layer-forming coating liquids S2 to S16 were prepared in the same manner as the protective layer-forming coating liquid S1, except that the type of the electron transporting compound, the amount of the electron donating compound, the amount of the curable compound (M-9050) and the amount of the polymerization initiators were changed as shown in Table 1, and for S3 and S4, the solvent was also changed to a mixed solvent of THF/2-propanol in a mass ratio of 3/7.

First, Examples and Comparative Examples of the first and third embodiments of the present invention are described below.

### <Production of Single-Layered Photoconductor>

Single-layered photoconductors were produced by the following procedures.

### Example 1-1

The undercoat layer-forming coating liquid P1 was immersion-coated on an aluminum cylinder having a diameter of 30 mm and a length of 244 mm with a machined surface to form an undercoat layer having a film thickness of 0.3 μm after drying. The single-layered photosensitive layer-forming coating liquid Q1 was immersion-coated on the undercoat layer and dried at 100° C. for 24 minutes to form a single-layered photosensitive layer having a film thickness of 32 μm after drying. The protective layer-forming coating liquid S1 was ring-coated on the single-layered photosensitive layer, and irradiated with LED light of 365 nm at an intensity of 0.9 W/cm² (108 J/cm²) for 2 minutes while rotating the photoconductor at 60 rpm under a nitrogen atmosphere immediately after coating to form a protective layer having a film thickness of 1.5 μm after curing, thereby producing a photoconductor A1-1.

### Examples 1-2 to 1-10 and Comparative Examples 1-1 to 1-7

Photoconductors A1-2 to A1-16 were produced in the same manner as the photoconductor A1-1, except that the protective layer-forming coating liquid S1 was changed to each of the protective layer-forming coating liquids S2 to S16.

### <Electrical Properties: Evaluation of Residual Potential>

Each of the photoconductors A1-1 to A1-16 obtained in Examples and Comparative Examples was mounted on an electrophotographic characteristic evaluation apparatus (described in “Zoku Denshishashin Gijutu no Kiso to Oyo” (Sequel to Fundamentals and Applications of Electrophotographic Technology), edited by The Society of Electrophotography of Japan, Corona Publishing Co., Ltd., pp. 404 to 405), prepared in accordance with the measurement standard of The Society of Electrophotography of Japan, to thereby measure the electrical properties through cycles of charging, exposure, potential measurement, and static elimination as follows.

First, the grid voltage was regulated to charge the photoconductor so as to have an initial surface potential (V0) of +700 V. The photoconductor was then irradiated with exposure light of 1.3 μJ/cm² to measure a residual potential (VL) at 60 milliseconds after irradiation. The exposure light used was monochromatic light of 780 nm extracted from halogen lamp light through an interference filter. The measurement was performed in an environment with a temperature of 25° C. and a relative humidity of 50% (N/N environment).

The results of the residual potential (VL) are shown in Table 1. The smaller the absolute value of the residual potential (VL), the more the charge has been sufficiently transported and the potential has been lowered, which can be considered a good result.

In addition, the VL difference depending on the presence or absence of an electron donating compound, i.e., the results of the calculation [(VL value in Example; with electron donating compound)−(VL value in Comparative Example; without electron donating compound)] are shown in Table 1. If the VL difference is a negative value, the VL value has been lowered by the inclusion of the electron donating compound, which can be considered good electrical properties.

In the first and third embodiments of the present invention, those having a negative value of the VL difference less than −1 were evaluated as “pass”.

### <Evaluation of Potential Retention Rate>

Each of the photoconductors A1-1 to A1-16 obtained in Examples and Comparative Examples was mounted on the electrophotographic characteristic evaluation apparatus described above, and the potential retention rate through cycles of charging, exposure, potential measurement, and static elimination was measured as follows.

To evaluate the electrical properties, the potential retention rate (%) was measured after charging to +700 V and holding for 5 seconds. The measurement was performed in an environment with a temperature of 25° C. and a relative humidity of 50% (N/N environment).

The results of the potential retention rate are shown in Table 1. The potential retention rate refers to the retention rate (%) of the surface potential when a photoconductor having a charged surface is left for a certain period of time. The higher the retention rate (%) of the surface potential, the better the potential is retained over time and the better the chargeability, which can be considered a good result.

### <Measurement of Martens Hardness and Elastic Deformation Rate>

For the photoconductors A1-1 to A1-16 obtained in Examples and Comparative Examples, the Martens hardness and the elastic deformation rate were measured from the surface side of each photoconductor using a microhardness tester (Fischerscope HM2000, manufactured by Fischer) in an environment with a temperature of 25° C. and a relative humidity of 50% under the following conditions.

### [Measurement Conditions of Martens Hardness and Elastic Deformation Rate]

Indenter: Vickers square pyramid diamond indenter with 136° facing angle
Maximum indentation load: 0.2 mN
Time required to load: 10 seconds
Time required to unload: 10 seconds

The Martens hardness can be determined by the following formula.

$$Martens hardness ( N / {mm}^{2} ) = maximum indentation load / indentation area at maximum indentation load$$

The elastic deformation rate is a value defined by the following formula, and is the ratio of the work performed by a film elasticity during unloading to the total work required for indentation.

$$Elastic deformation rate ( \% ) = ( We / Wt ) \times 100$$

In the formula, the total work Wt (nJ) represents an area surrounded by A-B-D-A in FIG. 2, and the elastic deformation work We (nJ) represents an area surrounded by C-B-D-C. The higher the elastic deformation ratio is, the less deformation remains under load, and an elastic deformation ratio of 100 means no residual deformation.

TABLE 1

| | | | | | | | | VL | | | |
|---|---|---|---|---|---|---|---|---|---|---|---|
| | Protective layer | | | | | | | diference | | | |
| | | | | | Content ratio | | | depending | | | |
| | | | | | of electron | | | on | | | |
| | Protective | | | Electron | donating | Poly- | | presence | | | Elastic |
| | layer- | Electron | Curable | donating | compound/ | merization | | or absence | Potential | | defor- |
| | forming | transporting | compound | compound | electron | initiator | Residual | of electron | retention | Hard- | mation |
| | coating | compound | (parts by | (parts by | transporting | (parts by | potential | donating | rate | ness | rate |
| | liquid | (parts by mass) | mass) | mass) | compound | mass) | VL (V) | compound | (%) | (N/mm²) | (%) |
| Example 1-1 | S1 | electron | M9050 | electron | 0.025 | TPO + | 247 | −62 | 74.5 | 200.3 | 35.7 |
| | | transporting | (50) | donating | | BP(9) | | | | | |
| | | compound 1 | | compound 1 | | | | | | | |
| | | (100) | | (2.5) | | | | | | | |
| Comparative | S2 | electron | M9050 | — | — | TPO + | 309 | | 82.2 | 202.8 | 36.5 |
| Example 1-1 | | transporting | (50) | | | BP(9) | | | | | |
| | | compound 1 | | | | | | | | | |
| | | (100) | | | | | | | | | |
| Example 1-2 | S3 | electron | — | electron | 0.025 | TPO + | 95 | −115 | 79.8 | 183 9 | 31.0 |
| | | transporting | | donating | | BP(6) | | | | | |
| | | compound 1 | | compound 1 | | | | | | | |
| | | (100) | | (2.5) | | | | | | | |
| Comparative | S4 | electron | — | — | — | TPO + | 210 | | 82.4 | 180.0 | 35.2 |
| Example 1-2 | | transporting | | | | BP(6) | | | | | |
| | | compound 1 | | | | | | | | | |
| | | (100) | | | | | | | | | |
| Example 1-3 | S5 | electron | M9050 | electron | 0.025 | TPO + | 253 | −56 | 74.1 | 216.6 | 38.2 |
| | | transporting | (50) | donating | | BP(9) | | | | | |
| | | compound 1 | | compound 2 | | | | | | | |
| | | (100) | | (2.5) | | | | | | | |
| Comparative | S6 | electron | M9050 | — | — | TPO + | 309 | | 82.2 | 202.8 | 36.5 |
| Example 1-3 | | transporting | (50) | | | BP(9) | | | | | |
| | | compound 1 | | | | | | | | | |
| | | (100) | | | | | | | | | |
| Example 1-4 | S7 | electron | M9050 | electron | 0.025 | TPO + | 100 | −33 | 73.8 | 211.3 | 35.2 |
| | | transporting | (50) | donating | | BP(9) | | | | | |
| | | compound 2 | | compound 1 | | | | | | | |
| | | (100) | | (2.5) | | | | | | | |
| Comparative | S8 | electron | M9050 | — | — | TPO + | 133 | | 77.3 | 203.1 | 35.5 |
| Example 1-4 | | transporting | (50) | | | BP(9) | | | | | |
| | | compound 2 | | | | | | | | | |
| | | (100) | | | | | | | | | |
| Example 1-5 | S9 | electron | M9050 | electron | 0.025 | TPO + | 101 | −32 | 77.3 | 202.4 | 34.0 |
| | | transporting | (50) | donating | | BP(9) | | | | | |
| | | compound 2 | | compound 2 | | | | | | | |
| | | (100) | | (2.5) | | | | | | | |
| Comparative | S10 | electron | M9050 | — | — | TPO + | 133 | | 77.3 | 203.1 | 35.5 |
| Example 1-5 | | transporting | (50) | | | BP(9) | | | | | |
| | | compound 2 | | | | | | | | | |
| | | (100) | | | | | | | | | |
| Example 1-6 | S11 | electron | M9050 | electron | 0.05 | TPO + | 111 | −38 | 71.4 | 206.5 | 33.2 |
| | | transporting | (100) | donating | | BP(12) | | | | | |
| | | compound 3 | | compound 1 | | | | | | | |
| | | (100) | | (5) | | | | | | | |
| Comparative | S12 | electron | M9050 | — | | TPO + | 149 | | 67.5 | 203.3 | 33.7 |
| Example 1-6 | | transporting | (100) | | | BP(12) | | | | | |
| | | compound 3 | | | | | | | | | |
| | | (100) | | | | | | | | | |
| Comparative | S13 | — | M9050 | electron | — | TPO + | 411 | — | 77.5 | 306.4 | 46.8 |
| Example 1-7 | | | (50) | donating | | BP(9) | | | | | |
| | | | | compound 1 | | | | | | | |
| | | | | (2.5) | | | | | | | |
| Example 1-8 | S14 | electron | M9050 | electron | 0.010 | TPO + | 274 | −35 | 78.6 | 220.4 | 37.5 |
| | | transporting | (50) | donating | | BP(9) | | | | | |
| | | compound 1 | | compound 1 | | | | | | | |
| | | (100) | | (1.0) | | | | | | | |
| Comparative | S2 | electron | M9050 | — | — | TPO + | 309 | | 822 | 202.8 | 36.5 |
| Example 1-1 | | transporting | (50) | | | BP(9) | | | | | |
| | | compound 1 | | | | | | | | | |
| | | (100) | | | | | | | | | |
| Example 1-9 | S15 | electron | M9050 | electron | 0.035 | TPO + | 243 | −66 | 71.1 | 218.1 | 36.6 |
| | | transporting | (50) | donating | | BP(9) | | | | | |
| | | compound 1 | | compound 1 | | | | | | | |
| | | (100) | | (3.5) | | | | | | | |
| Comparative | S2 | electron | M9050 | — | — | TPO + | 309 | | 82.2 | 202.8 | 36.5 |
| Example 1-1 | | transporting | (50) | | | BP(9) | | | | | |
| | | compound 1 | | | | | | | | | |
| | | (100) | | | | | | | | | |
| Example 1-10 | S16 | electron | M9050 | electron | 0.005 | TPO + | 306 | −3 | 795 | 2162 | 39.4 |
| | | transporting | (50) | donating | | BP(9) | | | | | |
| | | compound 1 | | compound 1 | | | | | | | |
| | | (100) | | (0.5) | | | | | | | |
| Comparative | S2 | electron | M9050 | — | — | TPO + | 309 | | 82.2 | 202.8 | 36.5 |
| Example 1-1 | | transporting | (50) | | | BP(9) | | | | | |
| | | compound 1 | | | | | | | | | |
| | | (100) | | | | | | | | | |

### Discussion

From the results in Table 1, it was confirmed that due to the addition of the electron donating compound (dopant), the residual potential (VL) in Example 1-1 was 62 V lower than that in Comparative Example 1-1.

It was confirmed that due to the addition of the electron donating compound (dopant), the residual potential (VL) in Example 1-2 was 115 V lower than that in Comparative Example 1-2.

It was confirmed that due to the addition of the electron donating compound (dopant), the residual potential (VL) in Example 1-3 was 56 V lower than that in Comparative Example 1-3.

It was confirmed that due to the addition of the electron donating compound (dopant), the residual potential (VL) in Example 1-4 was 33 V lower than that in Comparative Example 1-4.

It was confirmed that due to the addition of the electron donating compound (dopant), the residual potential (VL) in Example 1-5 was 32 V lower than that in Comparative Example 1-5.

It was confirmed that due to the addition of the electron donating compound (dopant), the residual potential (VL) in Example 1-6 was 38 V lower than that in Comparative Example 1-6.

It was confirmed that due to the addition of the electron donating compound (dopant), the residual potential (VL) in each of Examples 1-8, 1-9, and 1-10 was lower than that in Comparative Example 1-1 by 35 V, 66 V, and 3 V, respectively.

The above results show that when an electron donating compound is blended in the present protective layer, the electrical properties of the electrophotographic photoconductor, especially the residual potential properties, can be further improved. This is presumably because when an electron donating compound is present in the protective layer, the electrons donated by the electron donating compound make the electron transporting compound more likely to receive electrons, which further improves the electron transportability of the electron transporting compound and further increases the electron injection into the protective layer or the electron transporting performance, thereby further improving the electrical properties of the electrophotographic photoconductor, especially the residual potential properties.

The above results also show that even when the protective layer contains an electron donating compound, the potential retention rate, hardness, and elastic deformation rate remain the same and good.

Next, Examples and Comparative Examples of the second embodiment of the present invention are described below.

### <Production of Single-Layered Photoconductor>

Single-layered photoconductors were produced by the following procedures.

### Example 2-1

A photoconductor A2-1 was produced in the same manner as the photoconductor in Example 1-1.

### Examples 2-2 to 2-9 and Comparative Examples 2-1 to 2-8

Photoconductors A2-2 to A2-16 were produced in the same manner as the photoconductor A2-1, except that the protective layer-forming coating liquid S1 was changed to each of the protective layer-forming coating liquids S2 to S16.

### <Electrical Properties: Evaluation of Residual Potential>

For the photoconductors A2-1 to A2-16 obtained in Examples and Comparative Examples, the residual potential (VL) was measured by the method described above. The results of the residual potential (VL) are shown in Table 2.

In addition, the VL difference depending on the presence or absence of an electron donating compound, i.e., the results of the calculation [(VL value in Example; with electron donating compound)−(VL value in Comparative Example; without electron donating compound)] are shown in Table 2. If the VL difference is a negative value, the VL value has been lowered by the inclusion of the electron donating compound, which can be considered good electrical properties. In the second embodiment of the present invention, those having a negative value of the VL difference less than −10 were evaluated as “pass”.

### <Evaluation of Potential Retention Rate>

For the photoconductors A2-1 to A2-16 obtained in Examples and Comparative Examples, the potential retention rate (%) was measured by the method described above. The measurement results are shown in Table 2.

### <Measurement of Martens Hardness and Elastic Deformation Rate>

For the photoconductors A2-1 to A2-16 obtained in Examples and Comparative Examples, the Martens hardness (N/mm²) and the elastic deformation rate (%) were measured by the method described above. The measurement results are shown in Table 2.

TABLE 2

| | Protective layer | | | | | | | | | | |
|---|---|---|---|---|---|---|---|---|---|---|---|
| | | | | | Electron | | | | | | |
| | | | | | donating | | | | | | |
| | | | | | compound | | | | | | |
| | | | | | relative to | | | | | | |
| | | | | | 100 parts | | | VL | | | |
| | | | | | by mass | | | diference | | | |
| | | | | | of total | | | depending | | | |
| | Protective | Electron | | Electron | mass of | Poly- | | on presence | | | Elastic |
| | layer- | transporting | Curable | donating | protective | merization | | or absence | Potential | | defor- |
| | forming | compound | compound | compound | layer | initiator | Residual | of electron | retention | Hard- | mation |
| | coating | (parts by | (parts by | (parts by | (parts by | (parts by | potential | donating | rate | ness | rate |
| | liquid | mass) | mass) | mass) | mass) | mass) | VL (V) | compound | (%) | (N/mm²) | (%) |
| Example 2-1 | S1 | electron | M9050 | electron | 1.50 | TPO + | 247 | −62 | 74.5 | 200.3 | 35.7 |
| | | transporting | (50) | donating | | BP(9) | | | | | |
| | | compound 1 | | compound 1 | | | | | | | |
| | | (100) | | (2.5) | | | | | | | |
| Comparative | S2 | electron | M9050 | — | — | TPO + | 309 | | 82.2 | 202.8 | 36.5 |
| Example 2-1 | | transporting | (50) | | | BP(9) | | | | | |
| | | compound 1 | | | | | | | | | |
| | | (100) | | | | | | | | | |
| Example 2-2 | S3 | electron | — | electron | 2.30 | TPO + | 95 | −115 | 79.8 | 183.9 | 31.0 |
| | | transporting | | donating | | BP(6) | | | | | |
| | | compound 1 | | compound 1 | | | | | | | |
| | | (100) | | (2.5) | | | | | | | |
| Comparative | S4 | electron | — | — | — | TPO + | 210 | | 82.4 | 180.0 | 35.2 |
| Example 2-2 | | transporting | | | | BP(6) | | | | | |
| | | compound 1 | | | | | | | | | |
| | | (100) | | | | | | | | | |
| Example 2-3 | S5 | electron | M9050 | electron | 1.50 | TPO + | 253 | −56 | 74.1 | 216.6 | 38.2 |
| | | transporting | (50) | donating | | BP(9) | | | | | |
| | | compound 1 | | compound 2 | | | | | | | |
| | | (100) | | (2.5) | | | | | | | |
| Comparative | S6 | electron | M9050 | — | — | TPO + | 309 | | 82.2 | 202.8 | 36.5 |
| Example 2-3 | | transporting | (50) | | | BP(9) | | | | | |
| | | compound 1 | | | | | | | | | |
| | | (100) | | | | | | | | | |
| Example 2-4 | S7 | electron | M9050 | electron | 1.50 | TPO + | 100 | −33 | 73.8 | 211.3 | 35.2 |
| | | transporting | (50) | donating | | BP(9) | | | | | |
| | | compound 2 | | compound 1 | | | | | | | |
| | | (100) | | (2.5) | | | | | | | |
| Comparative | S8 | electron | M9050 | — | — | TPO + | 133 | | 77.3 | 203.1 | 35.5 |
| Example 2-4 | | transporting | (50) | | | BP(9) | | | | | |
| | | compound 2 | | | | | | | | | |
| | | (100) | | | | | | | | | |
| Example 2-5 | S9 | electron | M9050 | electron | 1.50 | TPO + | 101 | −32 | 77.3 | 202.4 | 34.0 |
| | | transporting | (50) | donating | | BP(9) | | | | | |
| | | compound 2 | | compound 2 | | | | | | | |
| | | (100) | | (2.5) | | | | | | | |
| Comparative | S10 | electron | M9050 | — | — | TPO + | 133 | | 77.3 | 203.1 | 35.5 |
| Example 2-5 | | transporting | (50) | | | BP(9) | | | | | |
| | | compound 2 | | | | | | | | | |
| | | (100) | | | | | | | | | |
| Example 2-6 | S11 | electron | M9050 | electron | 2.30 | TPO + | 111 | −38 | 71.4 | 206.5 | 33.2 |
| | | transporting | (100) | donating | | BP(12) | | | | | |
| | | compound 3 | | compound 1 | | | | | | | |
| | | (100) | | (5) | | | | | | | |
| Comparative | S12 | electron | M9050 | — | — | TPO + | 149 | | 87.5 | 203.3 | 33.7 |
| Example 2-6 | | transporting | (100) | | | BP(12) | | | | | |
| | | compound 3 | | | | | | | | | |
| | | (100) | | | | | | | | | |
| Comparative | S13 | — | M9050 | electron | — | TPO + | 411 | — | 77.5 | 308.4 | 46.8 |
| Example 2-7 | | | (50) | donating | | BP(9) | | | | | |
| | | | | compound 1 | | | | | | | |
| | | | | (2.5) | | | | | | | |
| Example 2-8 | S14 | electron | M9050 | electron | 0.63 | TPO + | 274 | −35 | 78.6 | 220.4 | 37.5 |
| | | transporting | (50) | donating | | BP(9) | | | | | |
| | | compound 1 | | compound 1 | | | | | | | |
| | | (100) | | (1.0) | | | | | | | |
| Comparative | S2 | electron | M9050 | — | — | TPO + | 309 | | 82.2 | 202.8 | 36.5 |
| Example 2-1 | | transporting | (50) | | | BP(9) | | | | | |
| | | compound 1 | | | | | | | | | |
| | | (100) | | | | | | | | | |
| Example 2-9 | S15 | electron | M9050 | electron | 2.15 | TPO + | 243 | −66 | 71.1 | 218.1 | 36.6 |
| | | transporting | (50) | donating | | BP(9) | | | | | |
| | | compound 1 | | compound 1 | | | | | | | |
| | | (100) | | (3.5) | | | | | | | |
| Comparative | S2 | electron | M9050 | — | — | TPO + | 309 | | 82.2 | 202.8 | 36.5 |
| Example 2-1 | | transporting | (50) | | | BP(9) | | | | | |
| | | compound 1 | | | | | | | | | |
| | | (100) | | | | | | | | | |
| Comparative | S16 | electron | M9050 | electron | 0.30 | TPO + | 306 | 3 | 79.5 | 216.2 | 39.4 |
| Example 2-8 | | transporting | (50) | donating | | BP(9) | | | | | |
| | | compound 1 | | compound 1 | | | | | | | |
| | | (100) | | (0.5) | | | | | | | |
| Comparative | S2 | electron | M9050 | — | — | TPO + | 309 | | 82.2 | 202.8 | 36.5 |
| Example 2-1 | | transporting | (50) | | | BP(9) | | | | | |
| | | compound 1 | | | | | | | | | |
| | | (100) | | | | | | | | | |

### Discussion

From the results in Table 2, it was confirmed that due to the addition of the electron donating compound (dopant), the residual potential (VL) in Example 2-1 was 62 V lower than that in Comparative Example 2-1.

It was confirmed that due to the addition of the electron donating compound (dopant), the residual potential (VL) in Example 2-2 was 115 V lower than that in Comparative Example 2-2.

It was confirmed that due to the addition of the electron donating compound (dopant), the residual potential (VL) in Example 2-3 was 56 V lower than that in Comparative Example 2-3.

It was confirmed that due to the addition of the electron donating compound (dopant), the residual potential (VL) in Example 2-4 was 33 V lower than that in Comparative Example 2-4.

It was confirmed that due to the addition of the electron donating compound (dopant), the residual potential (VL) in Example 2-5 was 32 V lower than that in Comparative Example 2-5.

It was confirmed that due to the addition of the electron donating compound (dopant), the residual potential (VL) in Example 2-6 was 38 V lower than that in Comparative Example 2-6.

It was confirmed that due to the addition of the electron donating compound (dopant), the residual potential (VL) in each of Examples 2-8 and 2-9 was lower than that in Comparative Example 2-1 by 35 V and 66 V, respectively.

The above results show that when an electron donating compound is blended in the present protective layer, the electrical properties of the electrophotographic photoconductor, especially the residual potential properties, can be further improved. This is presumably because when an electron donating compound is present in the protective layer, the electrons donated by the electron donating compound make the electron transporting compound more likely to receive electrons, which further improves the electron transportability of the electron transporting compound and further increases the electron injection into the protective layer or the electron transporting performance, thereby further improving the electrical properties of the electrophotographic photoconductor, especially the residual potential properties.

The above results also show that even when the protective layer contains an electron donating compound, the potential retention rate, hardness, and elastic deformation rate remain the same and good.

### EXPLANATIONS OF LETTERS OR NUMERALS

1 Photoconductor (Electrophotographic Photoconductor)
2 Charging Device (Charging Roller; Charging Section)
3 Exposing Device (Exposing Section)
4 Developing Device (Developing Section)
5 Transferring Device
6 Cleaning Device
7 Fixing Device
41 Developing Tank
42 Agitator
43 Supplying Roller
44 Developing Roller
45 Regulating Member
71 Upper Fixing Member (Pressure Roller)
72 Lower Fixing Member (Fixing Roller)
73 Heating Device
T Toner
P Printing Paper (Paper, Medium)

1. An electrophotographic photoconductor comprising a photosensitive layer and a protective layer in sequence on a conductive support,
wherein the protective layer comprises an electron donating compound, and
the electron donating compound comprises a compound having a benzimidazole structure or a guanidine structure.

2. The electrophotographic photoconductor according to claim 1, wherein the protective layer comprises a cured product obtained by curing a photocurable compound.

3. The electrophotographic photoconductor according to claim 1, wherein a content of the electron donating compound in the protective layer is 0.62 part by mass or more relative to a total mass of the protective layer being 100 parts by mass.

4. The electrophotographic photoconductor according to claim 1,
wherein the protective layer further comprises an electron transporting compound, and
a content mass ratio of the electron donating compound to the electron transporting compound is 0.001 or more and 0.8 or less.

5. The electrophotographic photoconductor according to claim 1, wherein the electron donating compound comprises an electron donating compound represented by the following formula (2) or (3), 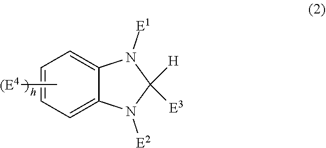
wherein E¹ to E⁴ each independently represent a hydrogen atom, a halogen atom, an optionally substituted alkyl group, an optionally substituted thioalkyl group, an optionally substituted thioaryl group, an optionally substituted arylsulfonyl group, an optionally substituted amino group, an optionally substituted alkylamino group, an optionally substituted arylamino group, an optionally substituted hydroxy group, an optionally substituted alkoxy group, an optionally substituted acylamino group, an optionally substituted acyloxy group, an optionally substituted aromatic hydrocarbon group, an optionally substituted carboxy group, an optionally substituted carboxamido group, an optionally substituted carboalkoxy group, an optionally substituted acyl group, an optionally substituted sulfonyl group, an optionally substituted cyano group, or an optionally substituted nitro group; E¹ to E⁴ may be bonded to each other to form a ring; and h represents an integer from 0 to 4; 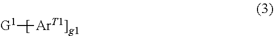
wherein Ar^{T1} is represented by the following formula (4), G¹ represents an optionally substituted hydrocarbon group, and g1 represents an integer of 1 or more, and 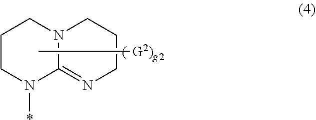
wherein the asterisk (*) represents a bond with G¹ in the formula (3), G² represents an optionally substituted alkyl group, an optionally substituted alkoxy group, or a halogen atom, and g2 represents an integer of 0 or more.

6. The electrophotographic photoconductor according to claim 5, wherein the electron donating compound comprises at least one selected from the group consisting of compounds represented by the following formulae.

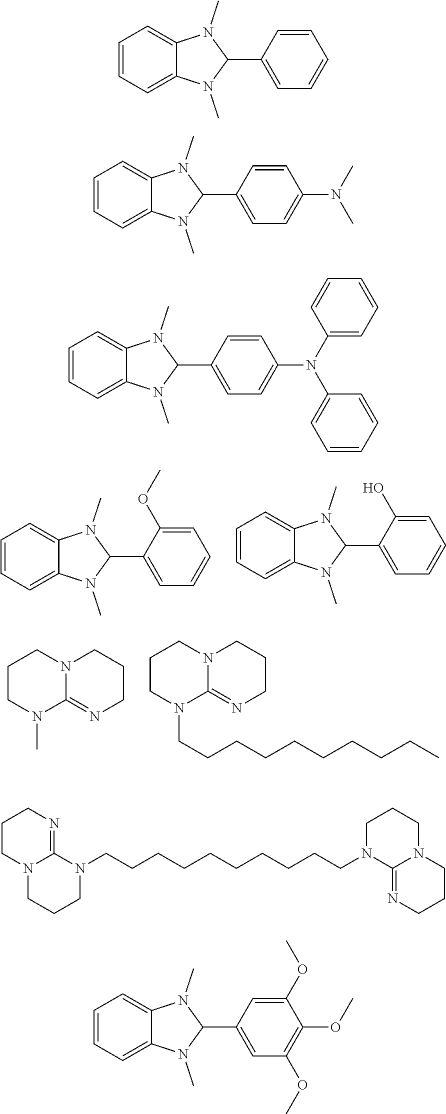

7. The electrophotographic photoconductor according to claim 1, wherein the protective layer further comprises an electron transporting compound.

8. The electrophotographic photoconductor according to claim 7, wherein a content mass ratio of the electron donating compound to the electron transporting compound is 0.001 or more and 1.0 or less.

9. The electrophotographic photoconductor according to claim 4, wherein the electron transporting compound comprises an electron transporting compound represented by the following formula (1), 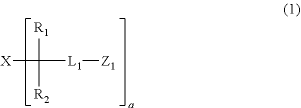
wherein X represents an electron transporting skeleton; R₁ and R₂ each independently represent a hydrogen atom, an optionally substituted alkyl group, an optionally substituted alkoxy group, an optionally substituted aryloxy group, an optionally substituted heteroaryloxy group, an optionally substituted alkoxycarbonyl group, an optionally substituted dialkylamino group, an optionally substituted diarylamino group, an optionally substituted arylalkylamino group, an optionally substituted acyl group, an optionally substituted haloalkyl group, an optionally substituted alkylthio group, an optionally substituted arylthio group, an optionally substituted silyl group, an optionally substituted siloxy group, an optionally substituted aromatic hydrocarbon group, or an optionally substituted aromatic heterocyclic group; L₁ represents a divalent group; Z₁ represents a hydrogen atom, an alkoxy group, an amide group (—NHCO—R′), an acrylamide group, a methacrylamide group, an acryloyl group, or a methacryloyl group, where the aforementioned R′ represents a hydrogen atom, an optionally substituted alkyl group, an optionally substituted aralkyl group, or an optionally substituted aromatic group; a represents an integer of 1 or more; and when a is an integer of 2 or more, each of R₁, R₂, L₁, and Z₁ may be the same or different in the repeating structure.

10. The electrophotographic photoconductor according to claim 9, wherein X in the formula (1) has a structure selected from the group consisting of the following formulae (A-1) to (A-13) when the bonding site is substituted to a hydrogen atom, 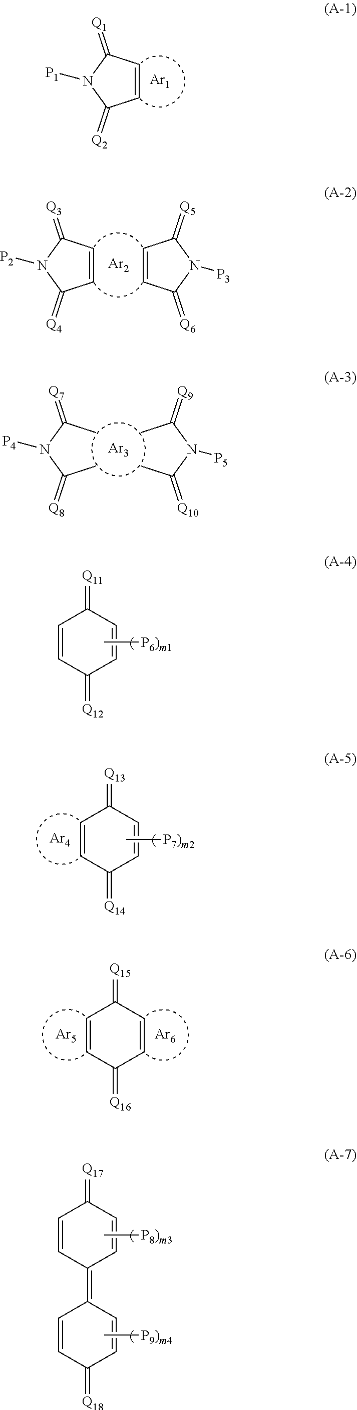 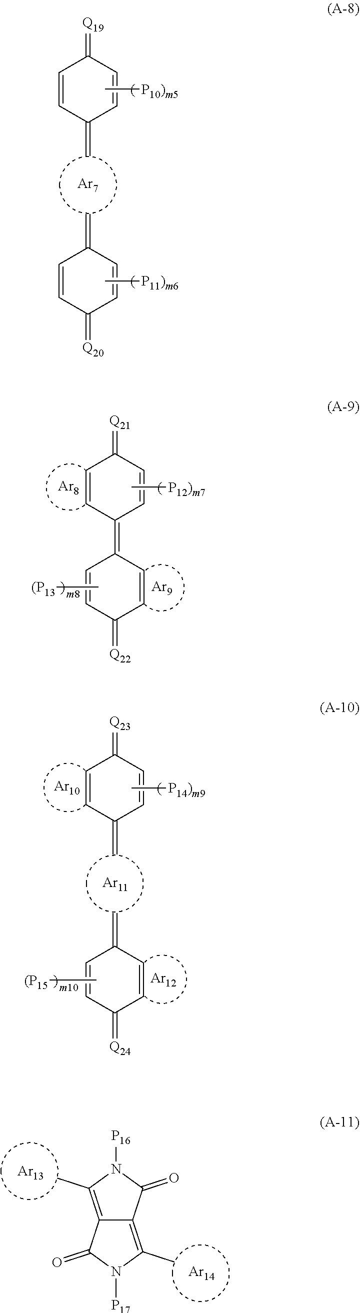 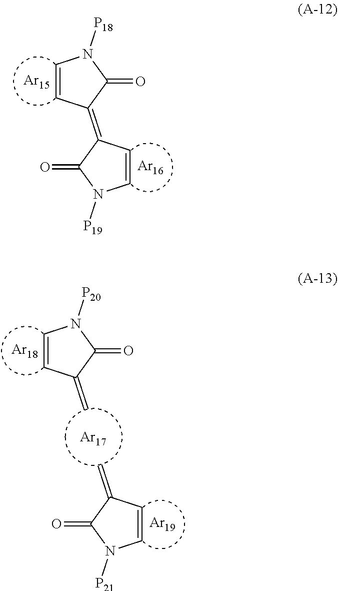
wherein P₁ to P₂₁ each independently represent a hydrogen atom, an optionally substituted alkyl group, an optionally substituted aralkyl group, an optionally substituted aromatic group, an optionally substituted alkoxy group, an optionally substituted aryloxy group, an optionally substituted acyl group, an optionally substituted ester group, an optionally substituted cyano group, an optionally substituted nitro group, an optionally substituted sulfone group, an optionally substituted hydroxy group, an optionally substituted aldehyde group, or a halogen atom; m1 to m10 each independently represent an integer of 0 or more; when m1 to m10 are each an integer of 2 or more, each of P₆ to P₁₅ may be the same or different in the repeating structure; Q₁ to Q₂₄ each independently represent either an oxygen atom, a sulfur atom, C(CN)₂, CR″CN, CA₂, C(COOR″)₂, CR′COOR″, NR″, or NCR″, where the aforementioned A represents a halogen atom, and the aforementioned R″ represents a hydrogen atom, an optionally substituted alkyl group, an optionally substituted alkoxy group, an optionally substituted aryloxy group, an optionally substituted heteroaryloxy group, an optionally substituted alkoxycarbonyl group, an optionally substituted dialkylamino group, an optionally substituted diarylamino group, an optionally substituted arylalkylamino group, an optionally substituted acyl group, an optionally substituted haloalkyl group, an optionally substituted alkylthio group, an optionally substituted arylthio group, an optionally substituted silyl group, an optionally substituted siloxy group, an optionally substituted aromatic hydrocarbon group, or an optionally substituted aromatic heterocyclic group; and Ar₁ to Ar₁₉ each independently represent an optionally substituted aromatic group or an optionally substituted heteroaromatic group.

11. The electrophotographic photoconductor according to claim 9, wherein X in the formula (1) has a structure selected from the group consisting of the following formulae (B-1) to (B-38) when the bonding site is substituted to a hydrogen atom, 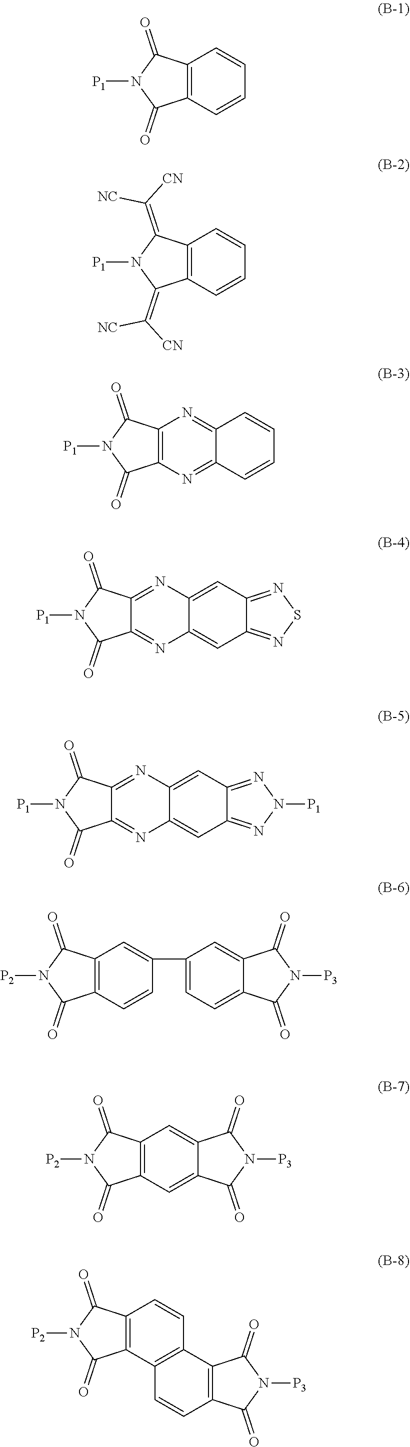 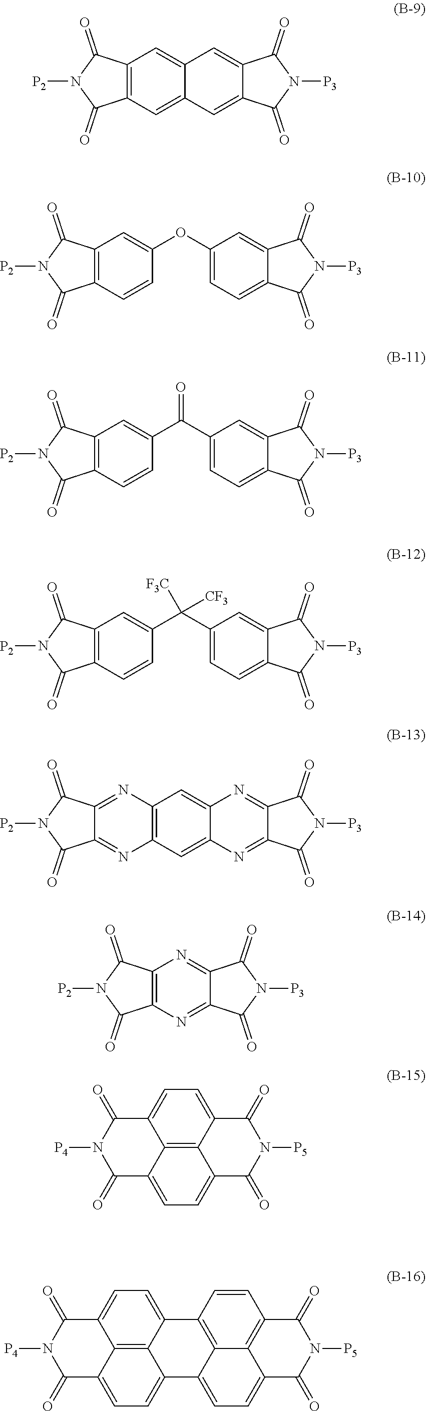 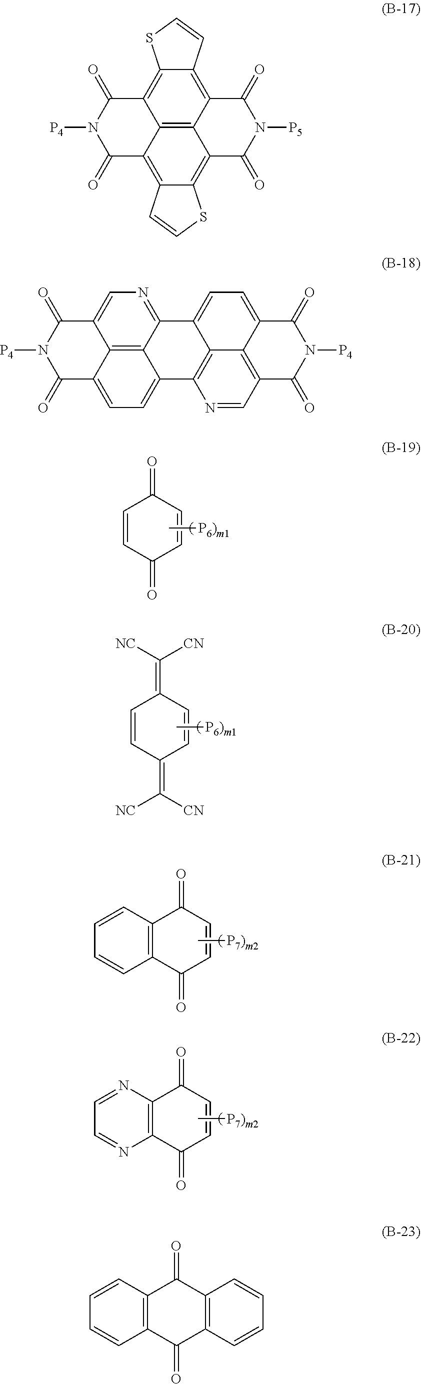 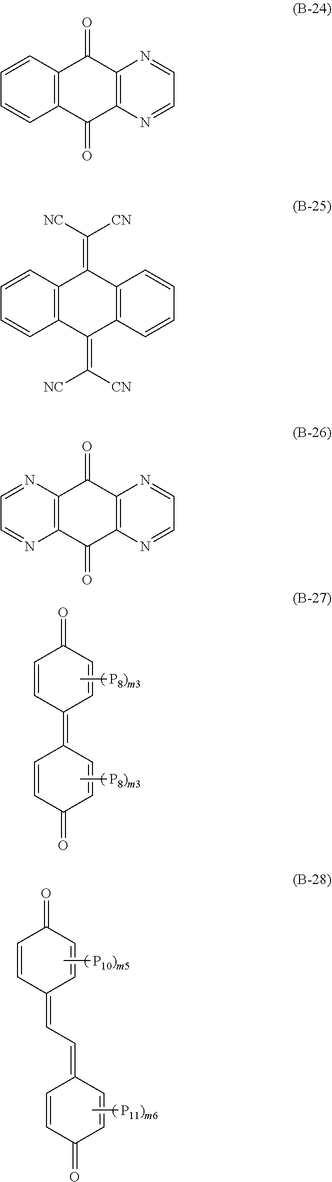 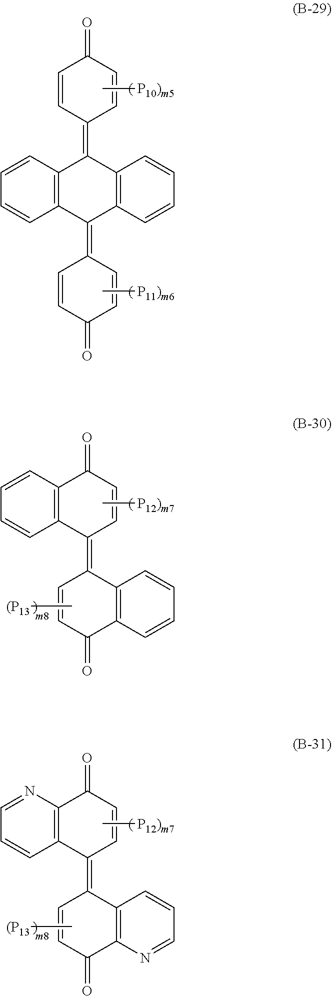 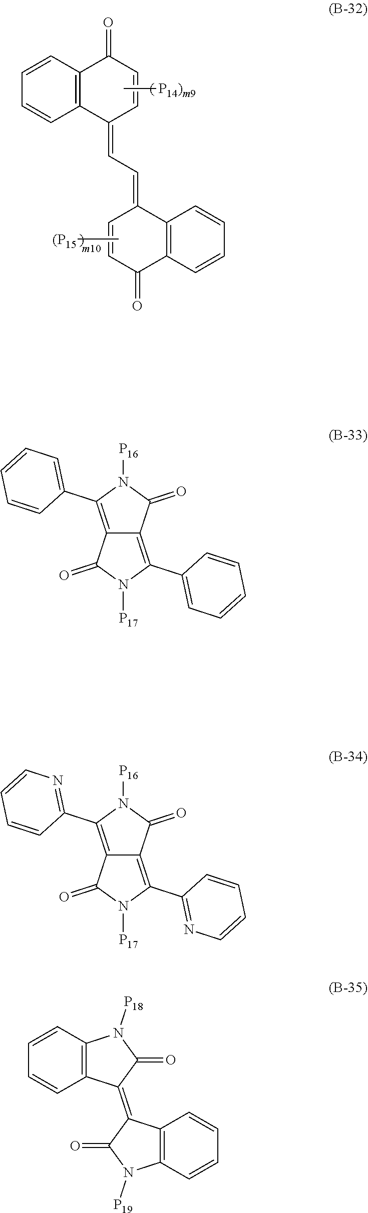 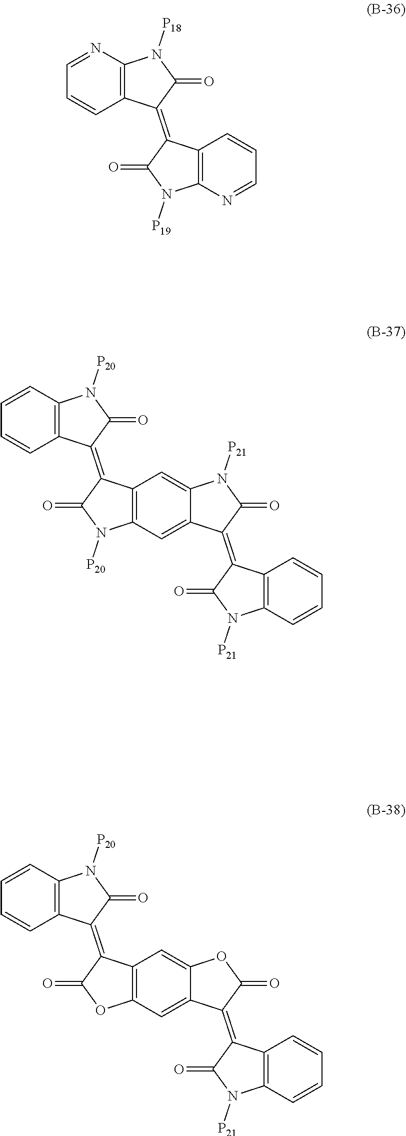
wherein P₁ to P₂₁ each independently represent a hydrogen atom, an optionally substituted alkyl group, an optionally substituted aralkyl group, an optionally substituted aromatic group, an optionally substituted alkoxy group, an optionally substituted aryloxy group, an optionally substituted acyl group, an optionally substituted ester group, an optionally substituted cyano group, an optionally substituted nitro group, an optionally substituted sulfone group, an optionally substituted hydroxy group, an optionally substituted aldehyde group, or a halogen atom; m1 to m10 each independently represent an integer of 0 or more; and when m1 to m10 are each an integer of 2 or more, each of P₆ to P₁₅ may be the same or different in the repeating structure.

12. The electrophotographic photoconductor according to claim 9, wherein L₁ in the formula (1) represents an alkylene group, a divalent group having a ketone group, a divalent group having an ether bond, a divalent group having an ester bond, or a group in which these are linked.

13. An electrophotographic photoconductor cartridge comprising the electrophotographic photoconductor according to claim 1.

14. An image formation device comprising the electrophotographic photoconductor according to claim 1.
